(19) United States
(12) Patent Application Publication
(10) Pub. No.: US 2019/0181680 A1
(43) Pub. Date: Jun. 13, 2019

(54) CONTROL DEVICE OPTIMIZING EVALUATION OF ENERGY MANAGEMENT IN IN-PLANT ENERGY NETWORK

(71) Applicant: Yanmar Co., Ltd., Osaka-shi, Osaka-fu (JP)

(72) Inventors: Sandro MAGNANI, Firenze (IT); Alessandro BELLISSIMA, Firenze (IT); Mirko ANDREINI, Firenze (IT); Lorenzo FERRARI, Firenze (IT); Giovanni FERRARA, Firenze (IT); Fabio ESPOSITO, Firenze (IT); Michele BECCIANI, Firenze (IT)

(73) Assignee: Yanmar Co., Ltd., Osaka-shi, Osaka-fu (JP)

(21) Appl. No.: 16/324,057

(22) PCT Filed: Aug. 9, 2016
(86) PCT No.: PCT/JP2016/003680

§ 371 Date: Feb. 7, 2019

(51) Int. Cl. H02J 13/00; H02J 3/32; H02J 3/38; G05B 19/042

(52) U.S. Cl. CPC H02J 13/0006; H02J 3/32; G05B 2219/2639; G05B 19/042; H02J 3/382

(57) ABSTRACT

A control device optimizing evaluation of energy management in an in-plant energy network by exploiting both electric and thermal energy in such a manner as to achieve desirable overall performance. The control device, optimizing evaluation of energy management in an in-plant energy network, improves energy facility efficiency and is applicable in residential areas (e.g., general households), manufacturing industry areas (e.g., factories), and tertiary areas (e.g., office buildings, hotels, hospitals, schools, and swimming pools) for which it is desirable to reduce at least one of energy supply cost, CO₂ (carbon dioxide) emission, and primary energy consumption.

### TECHNICAL FIELD

The present invention relates in general to control devices optimizing evaluation of energy management in an in-plant energy network by exploiting both electric and thermal energy in such a manner as to achieve desirable overall performance and in particular to control devices, optimizing evaluation of energy management in an in-plant energy network, that improve energy facility efficiency and are applicable in residential areas (e.g., general households), manufacturing industry areas (e.g., factories), and tertiary areas (e.g., office buildings, hotels, hospitals, schools, and swimming pools) for which it is desirable to reduce at least one of energy supply cost, CO₂ (carbon dioxide) emission, and primary energy consumption.

### BACKGROUND ART

An in-plant energy network that manages both electric and thermal energy for desirable overall performance connects to a large-scale electric power network (e.g., commercial electric power system) and includes an energy generation unit (for example, a combined heat and power device (CHP) and a renewable energy source (RES)), an energy storage unit (specifically, an electric storage unit and/or a thermal accumulation unit), and an energy load (specifically, an electric load and/or a thermal load). The in-plant energy network may further include a backup thermal energy supply unit.

These in-plant energy networks could fail to reduce at least one of energy supply cost, CO₂ emission, and primary energy consumption to expected levels even if the energy generation unit installed in the plant has relatively high efficiency. This is especially so when the energy generation unit needs to be integrated with another piece of equipment, such as an energy storage unit or an energy load (or a backup thermal energy supply unit). Some of the factors in this failure are facility managers' insufficient experience or competence in managing the equipment, such as the energy generation unit, the energy storage unit, and the energy load (possibly also, the backup thermal energy supply unit) and facility managers' insufficient understanding or knowledge in highly complex facilities and interactions between the installed pieces of equipment. In view of these problems, optimal management is desirable that reduces at least one of energy supply cost, CO₂ emission, and primary energy consumption in in-plant energy networks by specifying value settings for each piece of equipment, including the energy generation unit, the energy storage unit, and the energy load (possibly also, the backup thermal energy supply unit) even if the facility manager has insufficient knowledge or competence.

In relation to this desirable optimal management, related technical document 1 (US2014/0257584 A1) discloses a configuration that involves use of a genetic algorithm to optimize charging/discharging of rechargeable batteries in an energy network to which electrical appliances, electric loads, thermal appliances, and thermal loads are connected.

### SUMMARY OF INVENTION

### Technical Problems

However, as described in related technical document 1, according to conventional configurations, when there exist energy storage units (specifically, an electric storage unit and/or a thermal accumulation unit), even if a predetermined operation period (e.g., 1 day) is divided into a plurality of time steps, and an operation status of apparatus is calculated that results in an individual evaluation value representing an evaluation value for an individual time step (best evaluation value for each time step), optimal operation is not generally achieved when energy management is evaluated over the entire operation period by means of each transitional evaluation value representing an evaluation value for a transition from value settings for one time step to value settings for a next, consecutive time step.

Accordingly, the present invention has an object to provide a control device capable of practically achieving optimal operation of each piece of equipment, such as an energy generation unit, an energy storage unit, and an energy load, throughout an entire predetermined operation period.

Examples of other technical documents related to the present invention include:

“Smart energy management system for optimal microgrid operation”, by authors

Chen, Duan, Cai, Liu, Hu, from IET Renewable Power Generation, Volume 5, Issue 3, pp. 258-267, 2011. This technical document presents a Smart Energy Management System (SEMS), composed by several modules (for power forecasting, energy storage management, optimization), whose optimization is in the shape if a single-object optimization problem aiming to economically optimize the management of the storage, while the loads are managed by means of a real-coded genetic algorithm.

“Online management genetic algorithms of microgrid for residential application”, by Mohamed, Koivo, found in Energy Conversion and Management, Volume 64, pp. 562-568, 2012. The technique presented in this document performs the optimization of the microgrid by means of genetic algorithm only and in addition only economically optimizes the electric power generation, regardless of loads and thermal energy.

“Probabilistic energy and operation management of a microgrid containing wind/photovoltaic/fuel cell generation and energy storage devices based on point estimate method and self-adaptive gravitational search algorithm”, by Niknam, Golestaneh, Malekpour, in Energy, Volume 43, Issue 1, pp. 427-437, 2012. In this technical document, microgrid optimization is performed only for the electric side (neglecting the thermal one).

“Power source scheduling and adaptive load management via a genetic algorithm embedded neural network”, by Chih-Hsien, Devaney, Chung-Ming, Chih-Ming, from Instrumentation and Measurement Technology Conference (IMTC), 2000. This technical document presents an energy management system with a user-friendly interface.

“An algorithm for intelligent home energy management and demand response analysis”, by authors Pipattanasomporn, Kuzlu, Rahman, published in IEEE Transactions on Smart Grid, Volume 3, Issue 4, pp. 2166-2173, 2012. This technical document presents a method for the only demand side management, and only for the electric loads.

“Optimal and autonomous incentive-based energy consumption scheduling algorithm for smart grid”, by Mohsenian-Rad, Wong, Jatskevich, Schober, from Innovative Smart Grid Technologies (ISGT), 2010. In this technical document, management is only on the load side, and only for the electric power consumptions.

“Energy management and operational planning of a microgrid with a PV-based active generator for smart grid applications”, by authors Kanchev, Di, Colas, Lazarov, Francois, published in IEEE Transactions on Industrial Electronics, Volume 58, Issue 10, pp. 4583-4592, 2011. This technical document proposes a system that works considering two different space scales, global for the smart grid and local for the single user, optimizing the operations of both generators and storages, but regardless the load management and only considering the electric side.

“Autonomous demand-side management based on game-theoretic energy consumption scheduling for the future smart grid”, by Mohsenian-Rad, Wong, Jatskevich, Schober, Leon-Garcia, from IEEE Transactions on Smart Grid, Volume 1, Issue 3, pp. 320-331, 2010. This technical document presents a game-theoretic optimization carried out only on the electric loads.

“Application of a game-theoretic energy management algorithm in a hybrid predictive-adaptive scenario”, by Dave, Sooriyabandara, Luyang, by 2nd IEEE PES International Conference and Exhibition on Innovative Smart Grid Technologies (ISGT), 2011. This technical document presents, similarly to the previous one, an optimization carried out only for the electric loads by means of a game-theoretic-based algorithm.

“Demand side management in smart grid using heuristic optimization”, by authors Logenthiran, Srinivasan, Tan, published in IEEE Transactions on Smart Grid, Volume 3, Issue 3, pp. 1244-1252, 2012. This technical document presents management that is only carried out on the loads, without considering the generation side.

“Experimental validation of a real-time energy management system using multi-period gravitational search algorithm for microgrids in islanded mode”, by authors Marzband, Ghadimi, Sumper, Dominguez-Garcia, in Applied Energy, Volume 128, pp. 164-174, 2014. This technical document presents an optimization only carried out for the electric generation and loads.

“Real-time tool for management of smart polygeneration grids including thermal energy storage”, by authors Ferrari, Pascenti, Sorce, Traverso, Massardo, published in Applied Energy, Volume 130, pp. 670-678, 2014. This technical document presents an optimization carried out by a Simulink software toolbox. The operation of the plant is only managed with real-time signals.

“Plant management tools tested with a small-scale distributed generation laboratory”, by Ferrari, Traverso, Pascenti, Massardo, in Energy Conversion and Management, Volume 78, pp. 105-113, 2014. This technical document presents, similarly to the previously cited system, a system related to energy conversion and management.

Examples of software related to the technology of the present invention include Energy AnalityX by Iconics, Energy Sentinel Web and ES3 Evo by EnergyTeam, DEXCell Energy Manager by DEXMA, Wattics by Wattics, eSight by eSightenergy, AVReporter by KNOsys International, ENMAT Energy Management by ENMAT Energy, Acotel Energy Management by Acotel Net, Agentis Platform by Agentis Energy, ATLAS Energy Monitoring System by NewFound Energy, SIMATIC Powerrate by Siemens, SAP Eenergy Management Software by SAP, EnergyCAP by EnergyCAP, PowerLogic ION EEM by Schneider Electric, C3 Energy Customer Engagement Applications (by C3 Energy), and Energy Management Suite by Cisco.

A few more examples of software related to the technology of the present invention include:

Events2HVAC by Streamside Solutions, managing air conditioning, room heating, lighting systems, and door locking of single offices or rooms in large buildings once the occupation schedule is inputted.

Energy Management System Software by ETAP, aiming to manage large power production plants with an economic optimization based on power quality inputs from the field (voltage, frequency, and the like).

ASPEC by AlbaSystem, only managing generators with a real-time procedure aiming to minimize energy supply costs by deciding the priority interventions of a group of generators, with the objective of achieving the self-consumptions of the plant.

Energy Efficiency Platform Software by InspiringSoftware, claiming to manage and optimize the operations of both generators and loads (it is not completely clear how they do it).

As detailed so far, there exist technologies related to the present invention, none of which discloses the present invention.

### Solution to Problem

A control device in accordance with the present invention, to address the problems, is a control device optimizing evaluation of energy management in an in-plant energy network, the control device including an input section, a computing section, and an output section, the in-plant energy network being connected to a large-scale electric power network and including an energy generation unit, an energy storage unit, and an energy load, the input section being configured to allow input of input information for calculation of value settings for optimizing the evaluation of energy management in the in-plant energy network, the input information including vector information that is changeable over an entire predetermined operation period, scalar information that does not change throughout the entire operation period, and technical information representing characteristics of the energy generation unit and the energy storage unit, the computing section being configured to: compute, based on the input information, an output value of the energy generation unit and an output value of the energy storage unit and when the energy load includes a controllable energy load, also a demand of the controllable energy load, as the value settings by means of a predetermined optimization algorithm for each one of time steps into which the operation period is divided and for each one of predetermined levels of the energy storage unit; give a weight to each edge from the levels of the energy storage unit for one of the time steps to the levels of the energy storage unit for a next one of the time steps based on one of transitional evaluation values obtained by means of a fitness function; determine, out of combinations of the value settings resulting in the transitional evaluation values for the time steps, a combination of the value settings for which a total sum of the transitional evaluation values for a first one of the time steps to a last one of the time steps is most positively evaluated, by means of a graph-theoretic shortest-path problem solving algorithm; and select the combination of the value settings determined by means of the shortest-path problem solving algorithm as operational instruction values for each one of the time steps, the output section being configured to transmit the selected combination of the value settings as the operational instruction values to the energy generation unit and the energy storage unit and when the energy load includes the controllable energy load, also to the controllable energy load, for each one of the time steps.

In one aspect of the present invention, the shortest-path problem solving algorithm may be a Dijkstra algorithm.

In another aspect of the present invention, the optimization algorithm may be a genetic algorithm.

In a further aspect of the present invention, the vector information may include: at least one of an energy price, a time step-specific electric power price, an electric power demand, and a thermal power demand.

In still another aspect of the present invention, the scalar information may include at least one of a set of value settings in an operation season mode and a set of value settings for a last time step of an immediately preceding operation period.

The energy generation unit may include, for example, an electric energy generation unit and/or a thermal energy generation unit. More specifically, the energy generation unit may be a combined heat and power device (CHP) running on fuel gas, a renewable energy source (RES), or a cold thermal source. For example, in yet another aspect of the present invention, the energy generation unit may include a CHP and/or an RES.

The CHP may be, for example, a gas engine-based power generator, a fuel cell, or an organic rankine cycle (ORC). The RES may be, for example, a renewable electric energy source and/or a renewable thermal energy source. The renewable electric energy source may be, for example, a photovoltaic power generator or a wind-powered electric generator. The renewable thermal energy source may be, for example, a solar thermal collector.

The energy storage unit may be, for example, an electric storage unit and/or a thermal accumulation unit. The electric storage unit may be, for example, a rechargeable battery or a capacitor.

Thermal energy may include, for example, hot thermal energy and/or cold thermal energy. Therefore, the thermal accumulation unit may be, for example, a hot thermal accumulation unit and/or a cold thermal accumulation unit. The hot thermal accumulation unit may be, for example, a thermal accumulator (e.g., thermal water storage tank). The cold thermal accumulation unit may be, for example, a cooling storage device (e.g., cooling water tank).

The energy load may be an electric load and/or a thermal load. The electric load may be an electric lamp or an electrical appliance (e.g., electric cooling device). The thermal load may be, for example, a cold thermal load at lower-than-normal temperature in place of, or in addition to, a hot thermal load at higher-than-normal temperature. In other words, the thermal load may include a hot thermal load and/or a cold thermal load. The hot thermal load may be, for example, an air heating device. The cold thermal load may be, for example, an air cooling device.

In yet another aspect of the present invention, the technical information may include at least one of a rated output of the CHP, a conversion parameter for conversion of an electric energy output of the CHP to a fuel gas consumption of the CHP, and a conversion parameter for conversion of the electric energy output of the CHP to a thermal energy output of the CHP.

In another aspect of the present invention, the in-plant energy network may further include a backup thermal energy supply unit, the technical information may further include technical information representing characteristics of the backup thermal energy supply unit, the computing section may compute the output value of the energy generation unit, the output value of the energy storage unit, and an output value of the backup thermal energy supply unit and when the energy load includes the controllable energy load, also compute the demand of the controllable energy load, as the value settings by means of the optimization algorithm for each one of the time steps and for each one of the levels of the energy storage unit, and the output section may transmit the selected combination of the value settings as the operational instruction values to the energy generation unit, the energy storage unit, and the backup thermal energy supply unit and when the energy load includes the controllable energy load, also to the controllable energy load, for each one of the time steps.

The backup thermal energy supply unit may include a backup hot thermal energy supply unit and/or a backup cold thermal energy supply unit. The backup hot thermal energy supply unit may be, for example, a gas boiler or an electric boiler. The backup cold thermal energy supply unit may be, for example, an electric cooling device or an absorption cooling device.

In another aspect of the present invention, the transitional evaluation values may be derived from an evaluation condition including at least one of an energy supply cost, a CO₂ emission, and a primary energy consumption.

### Advantageous Effects of Invention

The present invention can practically achieve optimal operation of each piece of equipment, such as an energy generation unit, an energy storage unit, and an energy load, throughout an entire predetermined operation period.

### BRIEF DESCRIPTION OF DRAWINGS

FIG. 1 is a schematic illustration of an exemplary large-scale electric power network connected to an in-plant energy network in accordance with an embodiment of the present invention.

FIG. 2 is a schematic illustration of an exemplary in-plant energy network in accordance with an embodiment of the present invention.

FIG. 3 is a schematic block diagram illustrating in detail the in-plant energy network shown in FIG. 2.

FIG. 4 is a schematic block diagram illustrating a control device and related apparatus for the in-plant energy network shown in FIGS. 2 and 3.

FIG. 5 is a diagram representing an example of individual evaluation values for individual time steps into which an operation period is divided, depicting that the individual evaluation values for the time steps fail to achieve optimal operation when energy management is evaluated over the entire operation period.

FIG. 6 is a diagram representing an example of transitional evaluation values for evaluation by means of a combination of value settings for equipment, such as an energy generation unit, an energy storage unit, and an energy load, over an entire operation period, depicting that individual evaluation values for time steps into which an operation period is divided fail to achieve optimal operation when energy management is evaluated over the entire operation period.

FIG. 7 is a schematic illustration of a control structure of a control section in the control device shown in FIG. 4.

FIG. 8, related to the table in FIG. 6 of transitional evaluation values for evaluation by means of a combination of value settings in a transition from one time step to a next time step over an entire operation period, is a table of the output ratios of a CHP, an RES, and a backup thermal energy supply unit and the consumption ratios of an electric load and a thermal load, along with the output ratios of an electric storage unit and a thermal accumulation unit, for that one time step.

FIG. 9, related to the table in FIG. 6 of transitional evaluation values for evaluation by means of a combination of value settings in a transition from one time step to a next time step over an entire operation period, is a table of the output ratios of a CHP, an RES, and a backup thermal energy supply unit and the consumption ratios of an electric load and a thermal load, along with the output ratios of an electric storage unit and a thermal accumulation unit, for the next time step.

FIG. 10 is a flow chart representing a first half of an exemplary energy management evaluation optimization process performed by the control section in the control device shown in FIG. 7.

FIG. 11 is a flow chart representing a second half of the exemplary energy management evaluation optimization process performed by the control section in the control device shown in FIG. 7.

FIG. 12 is a schematic diagram illustrating an exemplary replacement process by which some individuals in a population are replaced, the left half representing the population before the replacement, the right half representing the population after the replacement.

FIG. 13 is a schematic diagram illustrating an exemplary selection process by which parent individuals are selected from two or more individuals in a population, the left half representing the population before the selection, the right half representing the population after the selection.

FIG. 14 is a diagram illustrating an exemplary roulette selection process, the left half representing selection rates, the right half representing a roulette wheel prepared according to the selection rates.

FIG. 15 is a schematic diagram illustrating an exemplary one-point crossover operation and an exemplary two-point crossover operation, the upper half representing a one-point crossover operation, the lower half representing a two-point crossover operation.

FIG. 16 is an illustration of local solutions that are likely to be found other than an optimal solution during the generation of a next-generation population.

FIG. 17 is a schematic diagram illustrating an exemplary single-locus mutation operation.

FIG. 18 is a schematic diagram of another exemplary in-plant energy network in accordance with an embodiment of the present invention.

FIG. 19 is a schematic diagram of another exemplary in-plant energy network in accordance with an embodiment of the present invention.

FIG. 20 is a schematic diagram of another exemplary in-plant energy network in accordance with an embodiment of the present invention.

FIG. 21 is a schematic diagram of another exemplary in-plant energy network in accordance with an embodiment of the present invention.

FIG. 22 is a schematic diagram of another exemplary in-plant energy network in accordance with an embodiment of the present invention.

FIG. 23 is a schematic diagram of another exemplary in-plant energy network in accordance with an embodiment of the present invention.

FIG. 24 is a schematic diagram of another exemplary in-plant energy network in accordance with an embodiment of the present invention.

FIG. 25 is a schematic diagram of another exemplary in-plant energy network in accordance with an embodiment of the present invention.

FIG. 26 is a schematic diagram of another exemplary in-plant energy network in accordance with an embodiment of the present invention.

FIG. 27 is a schematic diagram of another exemplary in-plant energy network in accordance with an embodiment of the present invention.

FIG. 28 is a schematic diagram of another exemplary in-plant energy network in accordance with an embodiment of the present invention.

FIG. 29 is a schematic diagram of another exemplary in-plant energy network in accordance with an embodiment of the present invention.

### DESCRIPTION OF EMBODIMENTS

The following will describe embodiments in accordance with the present invention in reference to drawings.

In-Plant Energy Network

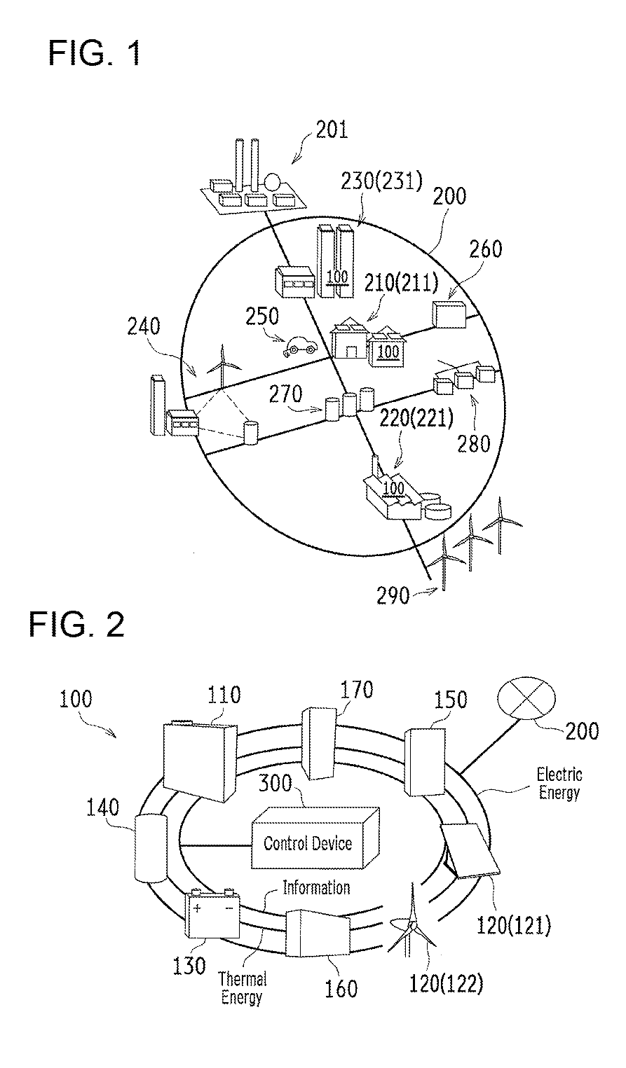

FIG. 1 is a schematic illustration of an exemplary large-scale electric power network 200 to which is connected an in-plant energy network 100 in accordance with an embodiment of the present invention.

The large-scale electric power network 200 is a large-scale commercial electric power system operating as an energy network (in this example, a smart energy network (smart grid)). A smart energy network enables exchange of electric power supply/demand information and also of various electric power-related information between electric power suppliers, such as electric power companies, and electric power consumers, such as residential areas (e.g., general households), manufacturing industry areas (e.g., factories), and tertiary areas (e.g., office buildings, hotels, hospitals, schools, and swimming pools) by using information communications technology. The energy network may be a non-smart energy network.

In the example shown in FIG. 1, the large-scale electric power network 200 connects a central power plant 201, a general household 211 as a residential area 210, a factory 221 as a manufacturing industry area 220, and an office 231 as a tertiary area 230, as well as a small-scale wind-powered plant 240, an electric vehicle 250, a combined heat and power system (CHP) 260, an electric storage unit 270, fuel cells 280, and a large-scale wind-powered plant 290 in such a manner as to enable exchange of electric power supply/demand information and various electric power-related information between the electric power suppliers and the electric power consumers.

At least one of the residential area 210, the manufacturing industry area 220, and the tertiary area 230 (in the example shown in FIG. 1, all of the residential area 210, the manufacturing industry area 220, and the tertiary area 230) includes the in-plant energy network 100.

In-Plant Energy Network

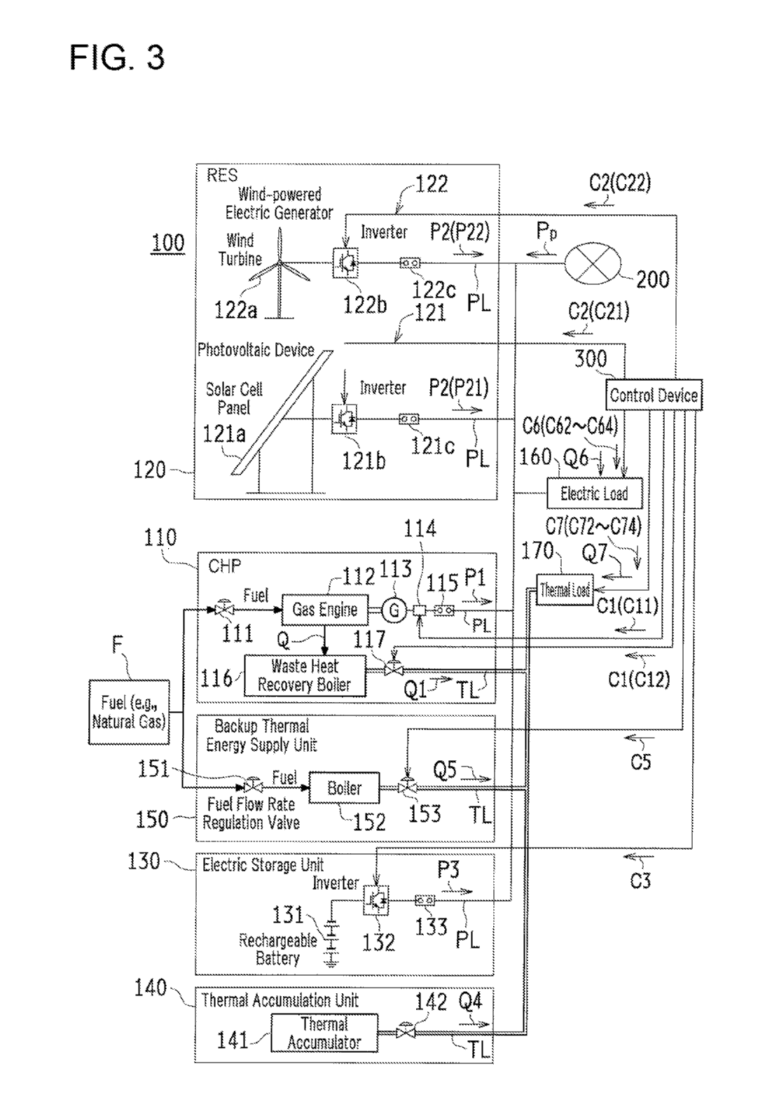

FIG. 2 is a schematic illustration of an example of the in-plant energy network 100 in accordance with an embodiment of the present invention. FIG. 3 is a schematic block diagram illustrating in detail the in-plant energy network 100 shown in FIG. 2.

As illustrated in FIGS. 2 and 3, the in-plant energy network 100 is applicable in at least one of the residential area 210, the manufacturing industry area 220, and the tertiary area 230 and operates as an electric and thermal energy network that manages both electric and thermal energy for desirable overall performance.

The in-plant energy network 100 is connected to the large-scale electric power network 200 and includes an energy generation unit (in this example, a combined heat and power device 110 (CHP 110) and a renewable energy source 120 (RES 120)), an energy storage unit (in this example, an electric storage unit 130 and a thermal accumulation unit 140), a backup thermal energy supply unit 150, and an energy load (in this example, an electric load 160 and a thermal load 170). Under the control of a control device 300, the in-plant energy network 100 operates the CHP 110, the RES 120, the electric storage unit 130, the backup thermal energy supply unit 150, the electric load 160, and the thermal load 170.

As illustrated in FIG. 3, the CHP 110 is a gas-powered electric generator in the present embodiment. The CHP 110 includes an open/close valve 111, a gas engine 112, an electric power generator 113, an electric power converter 114 for the electric power generator 113, an AC circuit breaker 115, a waste heat recovery boiler 116, and an adjusting valve 117.

In the CHP 110, the gas engine 112 runs on fuel supplied from a fuel supply source F via the open/close valve 111. The rotation of the gas engine 112 drives the electric power generator 113 for electric power generation. Generated electric energy P1 is fed to an electric power supply line PL via the AC circuit breaker 115. Also in the CHP 110, heat (waste heat) Q generated by the gas engine 112 heats up the waste heat recovery boiler 116. Thermal energy Q1 of obtained water vapor or hot water is fed to a heat supply line TL. Fuel, throughout this specification, may be, for example, gas fuel, such as natural gas, city gas, or biogas.

The CHP 110 is connected to an output system of the control device 300 so that the CHP 110 can change outputs thereof (electric energy P1 and thermal energy Q1) in response to an operational instruction value C1 from the control device 300 (i.e., an operational instruction value for an output ratio R1 (R11) with respect to the rated electric energy output, specifically an operational instruction value C11 for the duty ratio of a switching element in the electric power converter 114, and an operational instruction value for an output ratio R1 (R12) with respect to the rated thermal energy output, specifically an operational instruction value C12 for the opening degree of the adjusting valve 117 disposed on the heat supply line TL of the waste heat recovery boiler 116). As an example, for a rated electric energy output of 10 kWh and an output ratio R1 (R11) of 50%, the CHP 110 generates 5 kWh (electric energy P1) in response to an input from the control device 300 of the operational instruction value C11 dictating that the output ratio R1 (R11) with respect to the 10-kWh rated electric energy output be 50%. In addition, for a rated thermal energy output of 36,000 kJ and an output ratio R1 (R12) of 50%, the CHP 110 generates 18,000 kJ (thermal energy Q1) in response to an input from the control device 300 of the operational instruction value C12 dictating that the output ratio R1 (R12) with respect to the 36,000-kJ rated thermal energy output be 50%.

The RES 120 runs on natural energy to output electric energy and is connected to the output system of the control device 300. The RES 120 can change an output thereof in response to an operational instruction value C2 from the control device 300 (i.e., an operational instruction value for an output ratio R2 with respect to a maximum output) because the output of the RES 120 may need to be restricted to maintain predetermined electric power demand levels (e.g., an electric power exchange profile described later in detail) for the large-scale electric power network 200.

The RES 120 includes a photovoltaic power generator 121 and a wind-powered electric generator 122 in the present embodiment.

The photovoltaic power generator 121 includes a solar cell panel 121a, a solar-generated electric power inverter 121b, and an AC circuit breaker 121c. In the photovoltaic power generator 121, the solar cell panel 121a generates electric power under sunlight. The generated electric power is converted to AC electric energy P2 (P21) by the solar-generated electric power inverter 121b. The converted electric energy P2 (P21) is fed to the electric power supply line PL via the AC circuit breaker 121c. The photovoltaic power generator 121 is connected to the output system of the control device 300 so that the photovoltaic power generator 121 can change an output thereof (electric energy P21) in response to the operational instruction value C2 (C21) from the control device 300 (i.e., an operational instruction value for an output ratio R2 (R21) with respect to a maximum output of the solar cell panel 121a that depends on the intensity of sunlight, specifically an operational instruction value for the duty ratio of a switching element in the solar-generated electric power inverter 121b). As an example, where the solar cell panel 121a has a rated output of 10 kWh, but the solar cell panel 121a has a maximum output of 7 kWh as being determined by the intensity of sunlight, and the output ratio R21 is 50%, the photovoltaic power generator 121 delivers 3.5 kWh (electric energy output P2 (P21)) at the output of the solar-generated electric power inverter 121b in response to an input from the control device 300 of the operational instruction value C21 dictating that the output ratio R21 with respect to the 7-kWh maximum output be 50%.

The wind-powered electric generator 122 includes a wind turbine 122a, a wind-generated electric power inverter 122b, and an AC circuit breaker 122c. In the wind-powered electric generator 122, the wind turbine 122a rotates with wind for electric power generation. The generated electric power is converted to AC electric energy P2 (P22) by the wind-generated electric power inverter 122b. The converted electric energy P2 (P22) is fed to the electric power supply line PL via the AC circuit breaker 122c. The wind-powered electric generator 122 is connected to the output system of the control device 300 so that the wind-powered electric generator 122 can change an output thereof (electric energy P22) in response to the operational instruction value C2 (C22) from the control device 300 (i.e., an operational instruction value for an output ratio R2 (R22) with respect to a maximum output of the wind turbine 122a that depends on the wind air flow, specifically an operational instruction value for the duty ratio of a switching element in the wind-generated electric power inverter 122b). As an example, where the wind turbine 122a has a rated output of 5 kWh, but the wind turbine 122a has a maximum output of 3 kWh as being determined by the wind air flow, and the output ratio R22 is 50%, the wind-powered electric generator 122 delivers 1.5 kWh (electric energy output P2 (P22)) at the output of the wind-generated electric power inverter 122b in response to an input from the control device 300 of the operational instruction value C22 dictating that the output ratio R22 with respect to the 3-kWh maximum output be 50%.

In the present embodiment, the RES 120 exploits natural energy for electric energy output. This is however for illustrative purposes only. Examples of the RES 120 include those that exploit solar heat, geothermal heat, or another form of natural energy for thermal energy output.

The electric storage unit 130 in the present embodiment includes a rechargeable battery 131, an electric storage inverter 132, and an AC circuit breaker 133. The electric storage unit 130 is connected to the output system of the control device 300. In the electric storage unit 130, the rechargeable battery 131 is charged by an electric energy supply from the electric power supply line PL via a rectifier circuit (not shown) in response to an operational instruction value C3 from the control device 300 (i.e., an operational instruction value for an output ratio R3 with respect to a rated electric energy input). The rechargeable battery 131 also discharges DC electric energy, which is converted to AC electric energy P3 by the electric storage inverter 132 and fed to the electric power supply line PL via the AC circuit breaker 133, in response to the operational instruction value C3 from the control device 300 (i.e., an operational instruction value for the output ratio R3 with respect to a rated electric energy output).

The thermal accumulation unit 140, in the present embodiment, includes a thermal accumulator 141 (e.g., a thermal water storage tank) and a thermal energy regulation unit 142 (specifically, a thermal energy regulation valve). In the thermal accumulation unit 140, the thermal accumulator 141 stores thermal energy Q4 (e.g., in the form of water vapor or hot water) supplied from the heat supply line TL. The thermal accumulator 141 also delivers the thermal energy Q4 (e.g., in the form of water vapor or hot water) to the heat supply line TL via the thermal energy regulation unit 142.

The thermal accumulation unit 140 is not directly controlled by the control device 300, but indirectly controlled based on the balance of thermal energies Q1, Q7, and Q5 of thermal energy-related pieces of equipment (specifically, in this example, the CHP 110, the thermal load 170, and the backup thermal energy supply unit 150). As an example, assuming that the thermal load 170 is the thermal energy Q7 of 54,000 kJ, the control device 300 controls the CHP 110 so that the output of the CHP 110 is 36,000 kJ (thermal energy Q1). If the backup thermal energy supply unit 150 supplies no thermal energy Q5 (i.e., if the backup thermal energy supply unit 150 is controlled so that the backup thermal energy supply unit 150 outputs 0-kJ thermal energy Q5), then the thermal accumulation unit 140 is controlled to output 18,000 kJ at an output ratio R4 (e.g., 50% when the rated thermal energy output is 36,000 kJ).

The thermal accumulator 141 may include a cooling storage device (e.g., ice-making tank) capable of storing thermal energy at lower-than-normal temperature in place of, or in addition to, a heating storage device (e.g., thermal water storage tank) capable of storing thermal energy at higher-than-normal temperature.

The backup thermal energy supply unit 150 is a gas boiler in the present embodiment. The backup thermal energy supply unit 150 includes a fuel flow rate regulation valve 151, a boiler 152, and an adjusting valve 153. The backup thermal energy supply unit 150 heats the boiler 152 using fuel supplied from the fuel supply source F via the fuel flow rate regulation valve 151. The thermal energy Q5 of obtained water vapor or hot water is fed to the heat supply line TL in response to an operational instruction value C5 from the control device 300 (i.e., an operational instruction value for the output ratio R5 with respect to the rated thermal energy output, specifically an operational instruction value C5 for the opening degree of the adjusting valve 153 disposed on the heat supply line TL of the boiler 152). As an example, for a rated thermal energy output of 36,000 kJ and an output ratio R5 of 50%, the backup thermal energy supply unit 150 generates 18,000 kJ (thermal energy Q5) in response to an input from the control device 300 of the operational instruction value C5 dictating that the output ratio R5 with respect to the 36,000-kJ rated thermal energy output be 50%.

Examples of the electric load 160 include an electric lamp and an electrical appliance (e.g., electric cooling device). Examples of the thermal load 170 include an absorption cooling device, an air cooling device, and an air heating device. Conceptually, the thermal load 170 encompasses cold thermal loads at lower-than-normal temperature as well as hot thermal loads at higher-than-normal temperature. In other words, the thermal energy Q7 in the current context refers to both hot thermal energy and cold thermal energy.

The electric load 160 and the thermal load 170 may be classified into categories (a) to (d) as below.

(a) Non-Adjustable Loads (First Loads L1) that Consume Uninterruptible Energy Consumption for Energy Demand

First loads L1 are, for example, electric and air-conditioning appliances installed in a test laboratory where endurance tests are conducted, medical and air-conditioning appliances installed in a medical room (operating room, intensive care unit, and the like), and power supply and air-conditioning appliances installed in a computer room. The first load L1 is given highest priority because it needs to continuously consume electric and thermal energy. The first load L1 is therefore not controllable by the control device 300.

(b) Interruptible and Adjustable Loads (Second Loads L2)

Second loads L2 are, for example, electrical appliances, such as illuminating devices, and air-conditioning appliances installed in general residential areas, manufacturing industry areas, and tertiary areas. The second load L2 is a common load capable of alternating between consumption of electric and thermal energy and discontinuation of the consumption at any given time. The second load L2 is therefore controllable by the control device 300. The second load L2 is connected to the output system of the control device 300 so that the second load L2 can change electric and thermal energy consumption thereof in response to operational instruction values C6 (C62) and C7 (C72) from the control device 300 (i.e., operational instruction values for consumption ratios R6 (R62) and R7 (R72) of the second load L2 with respect to its rated energy consumption).

(c) Manageable Loads (Third Loads L3) that are, After Starting to Operate, Allowed to Discontinue Their Operation if a Total Operation Time is Reached Within a Predetermined Period of Time (e.g., on the Same Day)

Third loads L3 are, for example, washing machines in an industrial laundry facility, batch process machines, drilling machines, and battery chargers for electrical appliances. The third load L3 is capable of alternating between consumption of electric and thermal energy and discontinuation of the consumption at any given time if a predetermined total operation time is reached before or at the end of a predetermined period (e.g., at the end of the day). The third load L3 is therefore controllable by the control device 300. The third load L3 is connected to the output system of the control device 300 so that the third load L3 can change electric and thermal energy consumption thereof in response to operational instruction values C6 (C63) and C7 (C73) from the control device 300 (operational instruction values for consumption ratios R6 (R63) and R7 (R73) of the third load L3 with respect to its rated energy consumption).

(d) Manageable Loads (Fourth Loads L4) that are not Allowed to Discontinue Their Operation Until a Total Operation Time is Reached Once They Start to Operate

Fourth loads L4 are, for example, electric ovens, electric melting furnaces in foundries, and experimental devices, such as artificial climate chambers. The fourth load L4 is capable of alternating between consumption of electric and thermal energy and discontinuation of the consumption, but not allowed to discontinue its energy consumption for a certain continuous period of time once it starts to operate. The fourth load L4 is therefore controllable by the control device 300. The fourth load L4 is connected to the output system of the control device 300 so that the fourth load L4 can change electric and thermal energy consumption thereof in response to operational instruction values C6 (C64) and C7 (C74) from the control device 300 (operational instruction values for consumption ratios R6 (R64) and R7 (R74) of the fourth load L4 with respect to its rated energy consumption).

The electric power supply line PL is connected electrically to the CHP 110, the RES 120, the electric storage unit 130, the electric load 160, and the large-scale electric power network 200. The heat supply line TL is connected thermally to the CHP 110, the thermal accumulation unit 140, the backup thermal energy supply unit 150, and the thermal load 170. If the RES 120 exploits natural energy for thermal energy output, the heat supply line TL is also connected thermally to the RES 120.

Control Device

The control device 300 controls the whole in-plant energy network 100.

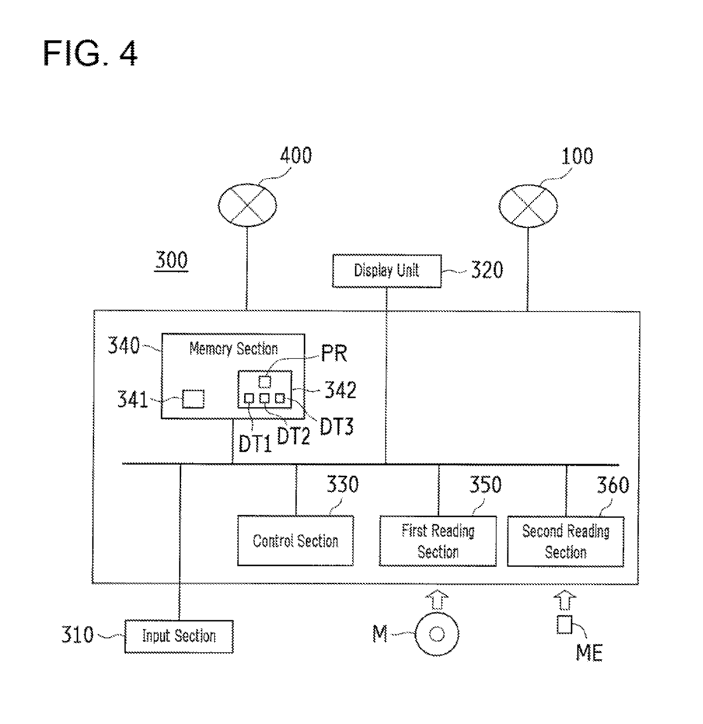

FIG. 4 is a schematic block diagram illustrating the control device 300 and related apparatus for the in-plant energy network 100 shown in FIGS. 2 and 3.

As illustrated in FIG. 4, the control device (computer) 300 is provided with external devices (man/machine interfaces) including an input section 310, such as a keyboard and a pointing device, and a display unit 320, such as a display device.

The control device 300, in this embodiment of the present invention, may be connected to the Internet 400, as well as to the in-plant energy network 100.

The control device 300 is provided with internal devices including a control section 330, a memory section 340, a first reading section 350, and a second reading section 360. The control section 330 is, for example, a CPU (central processing unit) and executes a computer program PR, computations, and other various processes. The memory section 340 contains a volatile memory 341, such as a RAM (random access memory), and a non-volatile memory 342, such as a ROM (read-only memory) and/or an electrically rewritable non-volatile ROM.

The control section 330 controls the display unit 320 to display various input screens so that the control section 330 can receive input of necessary information from the user operating the input section 310.

The volatile memory 341 is used, for example, as working memory when needed in the computations and other various processes executed by the control section 330. The non-volatile memory 342 includes, for example, a hard disk device and a flash memory.

The first reading section 350 is capable of reading a computer-readable storage medium M, such as a CD (compact disc)-ROM, containing the computer program PR. The non-volatile memory 342 pre-records software including the computer program PR which has been read by the first reading section 350. The storage medium M may be a USB (universal serial bus) memory or an SD (secure digital) memory card. The computer program PR may be downloaded over the Internet 400. The second reading section 360, in the present embodiment, reads an external storage medium ME. The external storage medium ME is typically a USB memory, but by no means limited to this example.

Energy demand data DT1, unit energy price data DT2, and weather condition data DT3 shown in FIG. 4 will be described later in detail.

As in the conventional configuration described earlier, even if the output values of the energy generation units (in this example, the CHP 110 and the RES 120), the energy storage units (in this example, the electric storage unit 130 and the thermal accumulation unit 140), and the backup thermal energy supply unit 150 that result in an individual evaluation value (best evaluation value) for each time step are calculated, and when there additionally exist controllable energy loads (in this example, the electric load 160 and the thermal load 170), also even if the demands of the controllable energy loads (in this example, the electric load 160 and the thermal load 170) that result in an individual evaluation value (best evaluation value) for each time step are calculated, optimal operation is not generally achieved when energy management is evaluated over the entire operation period by means of each transitional evaluation value for a transition from value settings for one time step to value settings for a next, consecutive time step.

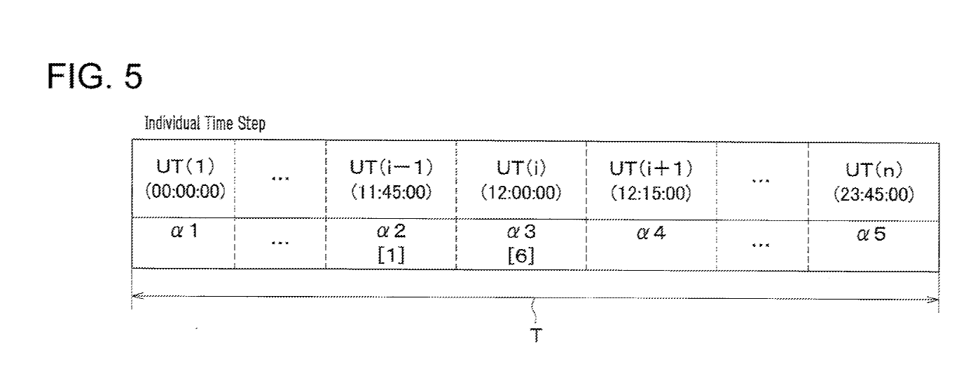

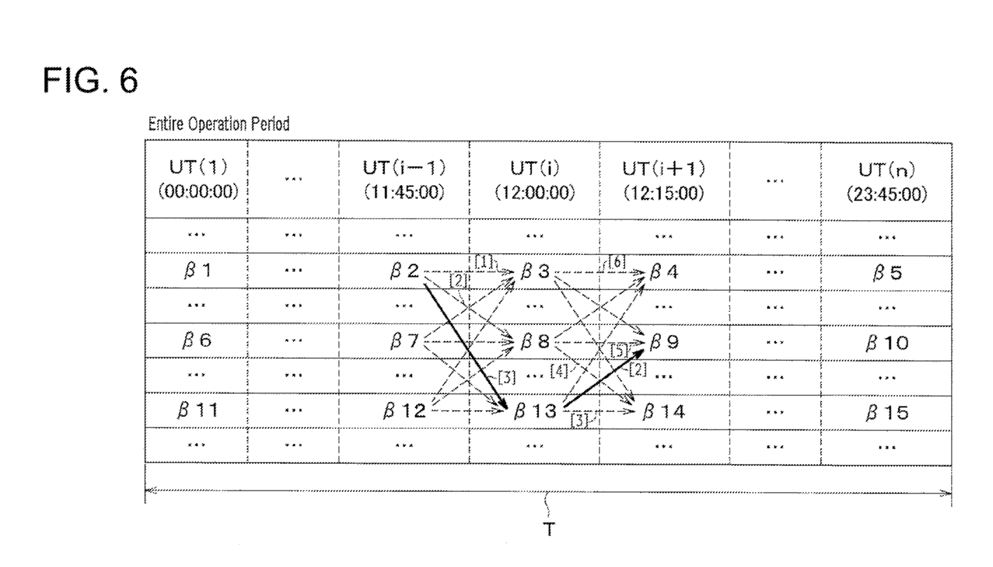

FIGS. 5 and 6 are tables depicting that individual evaluation values for a plurality of time steps UT(1) to UT(n) into which an operation period T is divided fail to achieve optimal operation when energy management is evaluated over the entire operation period T. FIG. 5 represents an example of individual evaluation values for individual time steps UT(1) to UT(n). FIG. 6 represents an example of transitional evaluation values for evaluation by means of a combination of value settings for each piece of equipment, such as energy generation units, energy storage units, and energy loads, over the entire operation period T. In this context, “n” is an integer greater than or equal to 2. In this example, the operation period T is 1 day, and the unitary time steps UT(1) to UT(n) are each 15 minutes. Therefore, “n” is 96, and “i” is an integer from 2 to 95. In addition, in this example, the evaluation values for time steps UT(1) to UT(n) are given as 7 numbers, [1] to [7]. A smaller evaluation value indicates more positive evaluation.

FIG. 5 shows, among individual time steps UT(1) to UT(n), for example, an individual evaluation value of [1] for a value setting α2 for time step UT(i−1) (e.g., 11 hours 45 minutes 00 seconds (“11:45:00”)) and an individual evaluation value of [6] for a value setting α3 for next, consecutive time step UT(i) (e.g., 12:00:00). In this example, the evaluation value, when energy management is evaluated over the entire operation period T, is equal to the sum of these values (e.g., . . . +[1]+[6]+ . . . =X).

Meanwhile, FIG. 6 shows transitional evaluation values (e.g., [1], [2], [3], . . . ) for a transition from value settings (e.g., β2, β7, β12) for time step UT(i−1) (e.g., 11:45:00) to value settings (e.g., β3, β8, β13) for next, consecutive time step UT(i) (e.g., 12:00:00) and transitional evaluation values (e.g., [6], [5], [4], [2], [3], . . . ) for a transition from value settings (e.g., β3, β8, β13) for time step UT(i) (e.g., 12:00:00) to value settings (e.g., β4, β9, β14) for further next, consecutive time step UT(i+1) (e.g., 12:15:00). When energy management is evaluated over the entire operation period T (in this example, 1 day) by means of a combination of these transitional evaluation values, the best evaluation value for this combination of value settings when energy management is evaluated over the entire operation period T (time steps UT(1) to UT(n)) is equal to the sum (for example, . . . +[3]+[2]+ . . . =Y (Y<X)) of the transitional evaluation value from time step UT(i−1) to next time step UT(i) (e.g., [3]) and the transitional evaluation value from next time step UT(i) to further next time step UT(i+1) (e.g., [2]). Throughout this specification, the transitional evaluation values are derived by means of a fitness function designed to reduce at least one of energy supply cost, CO₂ emission, and primary energy consumption in a transition from value settings for a time step to value settings for a next time step by using, as parameters, value settings for each piece of equipment, such as an energy generation unit, an energy storage unit, and a controllable energy load, as well as a backup thermal energy supply unit in this example.

As described above, an individual evaluation value is determined for each time step UT(1) to UT(n) in the conventional configuration. The evaluation value over the entire operation period T is therefore equal to the sum of these individual evaluation values for individual time steps UT(1) to UT(n) (in the example shown in FIG. 5, . . . +[1]+[6]+ . . . =X). This evaluation value over the entire operation period T generally and inherently represents less positive evaluation than the transitional evaluation values (in the example shown in FIG. 6, . . . +[3]+[2]+ . . . =Y<X), which is inconvenient.

Therefore, the conventional configuration does not practically achieve optimal operation of each piece of equipment, such as an energy generation unit, an energy storage unit, and energy loads, throughout the entire operation period T.

In the present embodiment, the following optimization of evaluation of energy management in the in-plant energy network 100 is performed by the control device 300 running the computer program PR.

Software Configuration for Computer Program

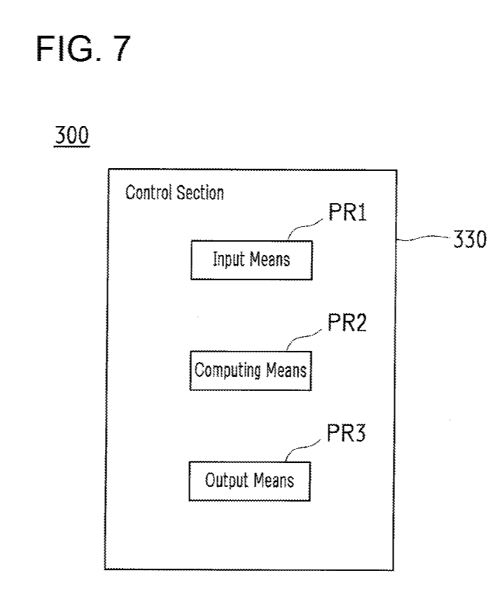

FIG. 7 is a schematic illustration of a control structure of the control section 330 in the control device 300 shown in FIG. 4.

The computer program PR enables the control section 330 in the control device 300 to function as various means including input means PR1 (an example of the input section), computing means PR2 (an example of a computing section), and output means PR3 (an example of an output section). In other words, the computer program PR enables the control device 300 (particularly, the control section 330) to perform steps including an input step corresponding to the input means PR1, a computing step corresponding to the computing means PR2, and an output step corresponding to the output means PR3. In other words, the control device 300 (specifically, the control section 330) functions as various means including the input means PR1, the computing means PR2, and the output means PR3.

Input Step

In the input step, predetermined input information is inputted to calculate value settings for optimizing the evaluation of energy management in the in-plant energy network 100. The predetermined input information includes vector information, scalar information, and technical information. The vector information may change over the entire predetermined operation period T (in this example, 1 day). The scalar information does not change throughout the entire operation period T. The technical information represents characteristics of the CHP 110, the RES 120, the electric storage unit 130, and the backup thermal energy supply unit 150.

Specifically, the vector information includes at least one of an energy price, a time step-specific electric power price, an electric power demand, and a thermal demand.

The scalar information includes at least one of a set of value settings in an operation season mode (e.g., an operation mode for air cooling and air heating) and a set of value settings (in this example, the output ratios R3 and R4 of the electric storage unit 130 and the thermal accumulation unit 140) for last time step UT(n) of an immediately preceding operation period T (in this example, the preceding day).

The technical information includes at least one of the rated output of the CHP 110, a conversion parameter for conversion of the electric energy output P1 of the CHP 110 to the fuel gas consumption of the CHP 110, and a conversion parameter for conversion of the electric energy output P1 of the CHP 110 to the thermal energy output Q1 of the CHP 110. The conversion parameter for conversion of the electric energy output P1 of the CHP 110 to the fuel gas consumption of the CHP 110 may be, for example, a coefficient (conversion coefficient) in a predetermined function (conversion formula) that yields a fuel gas consumption that corresponds to an engine load ratio. In addition, the thermal energy output Q1 of the CHP 110 varies, for example, depending on the electric power output of the CHP 110 (there exists a correlation with the electric power output of the CHP 110). Once the electric power output (specifically, engine rotational speed) is determined, the thermal waste of the CHP 110 is determined automatically. Therefore, the conversion parameter for conversion of the electric energy output P1 of the CHP 110 to the thermal energy output Q1 of the CHP 110 may be, for example, a coefficient (conversion coefficient) in a predetermined function (conversion formula) that yields a thermal waste of the CHP 110 that corresponds to the electric power output of the CHP 110.

In the input step, the control device 300 receives the energy demand data DT1 on forecast energy demands (see FIG. 4), the unit energy price data DT2 on unit energy prices (see FIG. 4), and the weather condition data DT3 on forecast weather conditions of the geographical region covered by the in-plant energy network 100 (see FIG. 4).

In the present embodiment, the energy demand data DT1 is directly inputted through the input section 310 by the user and obtained by the control device 300. The unit energy price data DT2 and the weather condition data DT3 are automatically obtained from a Web site on the Internet 400 by the control device 300.

The memory section 340 (e.g., the non-volatile memory 342) pre-records the energy demand data DT1 obtained by the input section 310. The memory section 340 (e.g., the non-volatile memory 342) also pre-records the unit energy price data DT2 and the weather condition data DT3 both obtained from a Web site on the Internet 400.

Each of the energy demand data DT1, the unit energy price data DT2, and the weather condition data DT3 is sets of time-sequential data on the processing target to be processed, covering a predetermined operation period T (e.g., 24 hours), with each set covering a predetermined time step UT (e.g., 15 minutes, or 0.25 hours) (unit time). The energy demand data DT1, the unit energy price data DT2, and the weather condition data DT3 therefore each consist of N sets of time-sequential data to be processed, where N=T/UT, or the operation period T divided by the unitary time step UT. For example, the energy demand data DT1, the unit energy price data DT2, and the weather condition data DT3 may cover a next single whole day (e.g., for a time step UT of 15 minutes, there are 24 hours/0.25 hours=96 processing units), half of a next day (either from midnight to noon or from noon to midnight) (e.g., for a time step UT of 15 minutes, there are 12 hours/0.25 hours=48 processing units), a shorter period of time, or a period of time that is longer than a single day.

The control device 300 optimizes energy management in advance (e.g., either collectively sometime on the preceding day (December 24) so that the optimization is completed by 00:00:00, December 25 or immediately before every time step UT on the day of interest (December 25) as necessary) before a forecast period for the energy demand data DT1 and the weather condition data DT3 (e.g., from 00:00:00 to 23:59:59, the next day (December 25)). The control device 300 also performs energy management for the in-plant energy network 100 in accordance with the processing units (e.g., 96 processing units when the time step UT is 15 minutes) of the corresponding time steps UT in the forecast period for the energy demand data DT1 and the weather condition data DT3 (e.g., 00:00:00 to 23:59:59, the day of interest (December 25)).

The energy demand data DT1 indicates an energy consumption for every time step UT in the forecast period including an uninterruptible energy consumption for energy demand (energy consumption of the first load L1).

The energy demand data DT1 indicates forecast electric power demands (forecast electric energy demands at equal time intervals) and forecast thermal energy demands (forecast thermal energy demands at equal time intervals). The energy demand data DT1 may indicate an electric power exchange profile for the large-scale electric power network 200. An electric power exchange profile in this context is information representing forecast electric power demands (forecast electric energy demands at equal time intervals) as agreed upon with a utility company (electric power company). If a consumer fails to follow the profile, he/she could be given a penalty.

In the present embodiment, the energy demand data DT1 is directly inputted to the control device 300 by the user. Alternatively, the energy demand data DT1 may be inputted to the control device 300 from a Web site on the Internet 400 or using the external storage medium ME (see FIG. 4). If the energy demand data DT1 is inputted from a Web site on the Internet 400, the memory section 340 (e.g., the non-volatile memory 342) pre-records the energy demand data DT1 inputted from the Web site. If the energy demand data DT1 is inputted using the external storage medium ME, the second reading section 360 reads the external storage medium ME containing the energy demand data DT1, and the memory section 340 (e.g., the non-volatile memory 342) pre-records the energy demand data DT1 which has been read by the second reading section 360.

The unit energy price data DT2 and the weather condition data DT3 are obtained from a Web site on the Internet 400. Alternatively, the unit energy price data DT2 and the weather condition data DT3 may be directly inputted to the control device 300 by the user and/or using the external storage medium ME. If the unit energy price data DT2 and/or the weather condition data DT3 are/is directly inputted by the user, the memory section 340 (e.g., the non-volatile memory 342) pre-records the unit energy price data DT2 and/or the weather condition data DT3 which have/has been directly inputted by the user. If the unit energy price data DT2 and/or the weather condition data DT3 are/is inputted using the external storage medium ME, the second reading section 360 reads the external storage medium ME containing the unit energy price data DT2 and/or the weather condition data DT3, and the memory section 340 (e.g., the non-volatile memory 342) pre-records the unit energy price data DT2 and/or the weather condition data DT3 which have/has been read by the second reading section 360.

Typical examples of the unit energy price data DT2 include a unit electric energy price per kilowatt-hour as an electric utility fee for the large-scale electric power network 200 and a unit thermal energy price per cubic meter of gas as a gas fee for the CHP 110 and the backup thermal energy supply unit 150. In the present embodiment, the CHP 110 and the backup thermal energy supply unit 150 use gas as their fuel and may use solid fuel. When this is the case, the unit energy price data DT2 may be, for example, a unit thermal energy price per unit weight of the solid fuel.

The weather condition data DT3 may be, as in the present embodiment, the angle of the sun and cloudiness if the RES 120 is the photovoltaic power generator 121 and the wind direction and speed if the RES 120 is the wind-powered electric generator 122. The weather condition data DT3 is weather condition data for the geographical region covered by the in-plant energy network 100, specifically weather condition data for the geographical region where the RES 120 (in this example, the photovoltaic power generator 121 and the wind-powered electric generator 122) is installed.

Computing Step

Based on the input information fed in the input step, the computing step computes the output values of the CHP 110, the RES 120, the electric storage unit 130, the thermal accumulation unit 140, and the backup thermal energy supply unit 150 (in this example, the output ratios R1, R2, R3, R4, and R5), and when there additionally exist a controllable electric load 160 and a controllable thermal load 170, also computes the demands of the controllable electric load 160 and thermal load 170 (in this example, the consumption ratios R6 and R7), as value settings by means of a predetermined optimization algorithm for each unitary time step UT(1) to UT(n) into which the operation period T is divided and for each one of predetermined levels of the electric storage unit 130 and the thermal accumulation unit 140 (in this example, 16 combinations of four levels, 20%, 50%, 70%, and 100%, of the electric storage unit 130 and four levels, 20%, 50%, 70%, and 100%, of the thermal accumulation unit 140).

The optimization algorithm may be any publicly known, conventional technique. Typical examples include sequential quadratic programming algorithms using information on the slope of an objective function and genetic algorithms that emulate biological evolution. The optimization algorithm in this example is a genetic algorithm.

The computing step repeatedly generates two or more energy balance candidates for each level (in this example, four levels: 20%, 50%, 70%, and 100%) of the electric storage unit 130 and each level (in this example, four levels: 20%, 50%, 70%, and 100%) of the thermal accumulation unit 140 for each time step UT (e.g., every 15 minutes) for the output (electric energy Pp) of the large-scale electric power network 200 and the output (thermal energy Q5) of the backup thermal energy supply unit 150 by combining varied values of the output ratio R1 of the CHP 110, the output ratio R2 of the RES 120, the output ratio R3 of the electric storage unit 130, the output ratio R4 of the thermal accumulation unit 140, the output ratio R5 of the backup thermal energy supply unit 150, the consumption ratio R6 of the electric load 160, and the consumption ratio R7 of the thermal load 170 until the convergence of the individual evaluation values of the two or more candidates reaches predetermined convergence criteria.

More particularly, the entire range of the output ratio R1 (from zero output (0%) to rated output (100%)) of the CHP 110 is evenly divided so that the range can be represented by a number of values (levels) that is equal to a predetermined division count DI (e.g., 2⁸=256 values or levels). Specifically, the output ratio R1 is 0% for “00000000” (=0 in decimal form), 1×100%/255=0.39% for “00000001” (=1 in decimal form), 2×100%/255=0.78% for “00000010” (=2 in decimal form), . . . , 254×100%/255=99.6% for “11111110” (=254 in decimal form), and 255×100%/255=100% for “11111111” (=255 in decimal form). Then, in the computing step, the output ratio R1 of the CHP 110 is converted to a value selected from the values obtained by the foregoing division of the range (specifically, those values that divide the range, 0% (00000000) to 100% (11111111), into 1/255 =0.39% intervals).

The same procedures may be applied to the entire ranges of the output ratio R2 of the RES 120 and the output ratio R5 of the backup thermal energy supply unit 150 so that the ranges can be evenly divided and represented by a number of values (levels) that is equal to a predetermined division count DI (e.g., 2⁸=256 values or levels).

Due to the performance of the CHP 110, the output ratio R2 of the CHP 110 may be set to 0%, or “00000000,” if it is less than or equal to a predetermined ratio (e.g., 10%).

The entire range of the consumption ratio R6 (from zero consumption (0%) to rated energy consumption (100%)) of the electric load 160 is evenly divided so that the range can be represented by a number of values (levels) that is equal to a predetermined division count DI (e.g., 2⁸=256 values or levels). Specifically, the consumption ratio R6 is 0% for “00000000” (=0 in decimal form), 1×100%/255=0.39% for “00000001” (=1 in decimal form), 2×100%/255=0.78% for “00000010” (=2 in decimal form), . . . , 254×100%/255=99.6% for “11111110” (=254 in decimal form), and 255×100%/255=100% for “11111111” (=255 in decimal form). Then, in the computing step, the consumption ratio R6 of the electric load 160 is converted to a value selected from the values obtained by the foregoing division of the range (specifically, those values that divide the range, 0% (00000000) to 100% (11111111), into 1/255=0.39% intervals).

The same procedures may be applied to the entire range of the consumption ratio R7 of the thermal load 170 so that the range can be evenly divided and represented by a number of values (levels) that is equal to a predetermined division count DI (e.g., 2⁸=256 values or levels).

The same procedures may be applied to the entire ranges of the output ratio R3 of the electric storage unit 130 and the resultant output ratio R4 of the thermal accumulation unit 140 so that the ranges (from zero output (0%) to rated output (100%)) can be evenly divided by a number of values (levels) that is equal to a predetermined division count DI (e.g., 2⁸=256 values or levels). However, taking into consideration the processing times of the optimization algorithm and the shortest-path problem solving algorithm, the output range of the electric storage unit 130 and the resultant output range of the thermal accumulation unit 140 are divided into approximately two to ten levels (in this example, four levels: 20%, 50%, 70%, and 100%). Specifically, the output ratios R3 and R4 are 51×100%/255=20% for “00110011” (=51 in decimal form), 128×100%/255=50.1% for “01000000” (=128 in decimal form), 179×100%/255=70.1% for “10110011” (=179 in decimal form), and 255×100%/255=100% for “11111111” (=255 in decimal form). Then, in the computing step, the output ratio R3 of the electric storage unit 130 and the resultant output ratio R4 of the thermal accumulation unit 140 are converted to values selected from the values obtained by the foregoing division of the range (specifically, those values that divide the range, 20% (00110011) to 100% (11111111), into 30.1%, 20%, and 29.9% intervals) so that the output range of the electric storage unit 130 and the resultant output range of the thermal accumulation unit 140 are represented by a number of values (levels) that is equal to a predetermined division count DJ.

The division count DI may assume different values for the output range of the CHP 110, the output range of the RES 120, the output range of the backup thermal energy supply unit 150, the consumption range of the electric load 160, and the consumption range of the thermal load 170. The division count DJ may assume different values for the output range of the electric storage unit 130 and the output range of the thermal accumulation unit 140.

The computing step includes a first calculation process, a second calculation process, an evaluation process, a first selection process, a weighting process, a shortest-path problem solving process, and a second selection process.

First Calculation Process

In the first calculation process, the outputs of the CHP 110 (electric energy P1 and thermal energy Q1) are calculated by multiplying the rated output of the CHP 110 and the output ratio R1 of the CHP 110 together.

Specifically, in the first calculation process, the entire range of the output ratio R11 of the electric energy P1 of the CHP 110 is evenly divided so that the range can be represented by 256 values. For example, when the rated electric energy output of the CHP 110 is 25.1 kWh, and the output ratio R11 of the CHP 110 is represented by “00111101” (=61 in decimal form), the output ratio R11 is 23.9%, and the electric energy P1 of the CHP 110 is 25.1 kWh×23.9%=6 kWh. The thermal energy Q1 of the CHP 110 can be similarly determined by evenly dividing the entire range of the thermal energy Q1 of the CHP 110 so that the output ratio R12 can be represented by 256 values.

Also in the first calculation process, the output of the RES 120 (in this example, the electric energy P2) is calculated by multiplying the maximum output of the RES 120 and the output ratio R2 of the RES 120, both based on weather conditions, together.

Specifically, in the first calculation process, if the RES 120 is the photovoltaic power generator 121, the entire range of the output ratio R21 of the photovoltaic power generator 121 is evenly divided so that the range can be represented by 256 values. The maximum output of the photovoltaic power generator 121 is then calculated using a photovoltaic cell conversion formula or table. The conversion formula and table are designed so that by using either of them, one can determine the maximum output of the photovoltaic power generator 121 from the intensity of sunlight given in the weather condition data DT3 in the form of the total solar radiation and ambient temperature. For example, when the maximum output of the photovoltaic power generator 121 is determined to be 2.51 kWh, and the output ratio R21 of the photovoltaic power generator 121 is represented by “00111101” (=61 in decimal form), the output ratio R21 is 23.9%, and the output (electric energy P21) of the photovoltaic power generator 121 is 2.51 kWh×23.9%=0.6 kWh. Likewise, if the RES 120 is the wind-powered electric generator 122, the output of the RES 120 is similarly determined using a wind-powered generator conversion formula or table that are designed so that by using either of them, one can determine the maximum output of the wind-powered electric generator 122 from the wind air flow given in the weather condition data DT3 in the form of wind direction and speed. If the RES 120 exploits natural energy for thermal energy output, its output (thermal energy) is similarly determined. The conversion formulas and tables may be predetermined (and stored in the memory section 340) based on, for example, the specifications of the RES 120.

Also in the first calculation process, the output of the backup thermal energy supply unit 150 (thermal energy Q5) is calculated by multiplying the rated output of the backup thermal energy supply unit 150 and the output ratio R5 of the backup thermal energy supply unit 150 together.

Specifically, in the first calculation process, the entire range of the output ratio R5 of the backup thermal energy supply unit 150 is evenly divided so that the range can be represented by 256 values. For example, when the rated thermal energy output of the backup thermal energy supply unit 150 is 86,000 kJ, and the output ratio R5 of the backup thermal energy supply unit 150 is represented by “00111101” (=61 in decimal form), the output ratio R5 is 23.9%, and the thermal energy output Q5 of the backup thermal energy supply unit 150 is 86,000 kJ×23.9%=20,554 kJ.

Also in the first calculation process, the output of the electric storage unit 130 (the electric energy P3) is calculated by multiplying the maximum output of the electric storage unit 130 and the output ratio R3 of the electric storage unit 130, based on the charge conditions, together.

Specifically, in the first calculation process, the entire range of the output ratio R3 of the electric storage unit 130 is evenly divided so that the range can be represented by 256 values. The maximum output of the electric storage unit 130 is then calculated based on the state of charge of the electric storage unit 130 and on the maximum energy content of the electric storage unit 130 so that by using either of them, one can determine the maximum output of the electric storage unit 130. For example, when the state of charge of the electric storage unit 130 is determined to be 50%, and the maximum energy content of the electric storage unit 130 is 5 kWh, the output ratio R3 of the electric storage unit 130 is represented by “00110011” (=51 in decimal form), the output ratio R3 is 20%, and the output (electric energy P3) of the electric storage unit 130 is 5 kWh×50%×20%=0.5 kWh.

Further in the first calculation process, the energy consumption Q6 (electric energy consumption) of the electric load 160 is calculated by multiplying the rated power consumption of the electric load 160 and the consumption ratio R6 of the electric load 160 together, and the energy consumption Q7 (thermal energy consumption) of the thermal load 170 is calculated by multiplying the rated power consumption of the thermal load 170 and the consumption ratio R7 of the thermal load 170 together. In this context, the energy consumption of the electric load 160 and that of the thermal load 170 are respectively parts other than the energy consumption of the first load L1.

Specifically, in the first calculation process, the entire range of the consumption ratio R6 of the electric load 160 is evenly divided so that the range can be represented by 256 values. For example, when the rated power consumption of the electric load 160 is 25.1 kWh, and the consumption ratio R6 of the electric load 160 is represented by “00111101” (=61 in decimal form), the consumption ratio R6 is 23.9%, and the energy consumption Q6 of the electric load 160 is 25.1 kWh×23.9%=6 kWh. The energy consumption Q7 of the thermal load 170 is similarly determined by evenly dividing the entire range of the consumption ratio R7 of the thermal load 170 so that the range can be represented by 256 values.

The output (thermal energy Q4) of the thermal accumulation unit 140 results from the supply/demand balance between the thermal energy Q7 consumed by the thermal load 170 and a sum (thermal energy Q1+Q5) of the thermal energy Q1 supplied from the CHP 110 and the thermal energy Q5 supplied from the backup thermal energy supply unit 150. Therefore, in the first calculation process, the output ratio R4 of the thermal accumulation unit 140 can be obtained by subtracting this sum (thermal energy Q1+Q5) from the thermal energy consumption Q7 of the thermal load 170 to obtain a differential thermal energy and dividing the differential thermal energy by the thermal charge level of the thermal accumulation unit 140 (=Maximum Thermal Charge Level of Thermal Accumulation Unit 140×Thermal Charge Ratio of Thermal Accumulation Unit 140). For example, assuming that the rated thermal energy output of the thermal accumulation unit 140 is 18,000 kJ, the thermal charge ratio of the thermal accumulation unit 140 is determined to be 50%. When the output ratio R4 of the thermal accumulation unit 140 is represented by “00110011” (=51 in decimal form), the output ratio R4 is 20%, and the output (thermal energy Q4) of the thermal accumulation unit 140 is 18,000 kJ×50%×20%=1,800 kJ.

Second Calculation Process

In the second calculation process, a difference between a total electric energy (total electric energy consumption) and another total electric energy (total electric energy supply) is calculated as an output (electric energy Pp) of the large-scale electric power network 200. The total electric energy consumption is a sum of the uninterruptible electric energy consumption manually fed in the input step and given in the energy demand data DT1 and the electric energy consumption Q6 of the electric load 160 obtained in the first calculation process. The total electric energy supply is a sum of the output (electric energy P1) of the CHP 110 obtained in the first calculation process, the output (electric energy P2) of the RES 120 obtained in the first calculation process, and the output (electric energy P3) of the electric storage unit 130 obtained in the first calculation process. Also in the second calculation process, a difference between a total thermal energy (total thermal energy consumption) and another total thermal energy (total thermal energy supply) is calculated as an output (thermal energy Q5) of the backup thermal energy supply unit 150. The total thermal energy consumption is a sum of the uninterruptible thermal energy consumption manually fed in the input step and given in the energy demand data DT1 and the thermal energy consumption Q7 of the thermal load 170 obtained in the first calculation process. The total thermal energy supply is a sum of the output (thermal energy Q1) of the CHP 110 and the output (thermal energy Q4) of the thermal accumulation unit 140 obtained in the first calculation process.

The uninterruptible electric energy consumption given in the energy demand data DT1 is the energy consumed by the first load L1, a part of the electric load 160. The uninterruptible thermal energy consumption given in the energy demand data DT1 is energy consumed by the first load L1 which is part of the thermal load 170.

The large-scale electric power network 200 covers an electric energy shortage in view of a total electric energy (total electric energy consumption; the sum of the uninterruptible electric energy consumption of the first load L1 given in the energy demand data DT1 and the electric energy consumptions of the second load L2, the third load L3, and the fourth load L4, each being a part of the electric load 160) and another total electric energy (total electric energy supply; the sum of the electric energy supply P1 from the CHP 110, the electric energy supply P2 from the RES 120, and the electric energy supply P3 from the electric storage unit 130). The backup thermal energy supply unit 150 covers a thermal energy shortage in view of a total thermal energy (total thermal energy consumption; the sum of the uninterruptible thermal energy consumption of the first load L1 given in the energy demand data DT1 and the thermal energy consumptions of the second load L2, the third load L3, and the fourth load L4 each of which is part of the thermal load 170) and another total thermal energy (total thermal energy supply; the sum of the thermal energy supply Q1 from the CHP 110 and the thermal energy supply Q4 from the thermal accumulation unit 140).

If the RES 120 exploits natural energy for thermal energy output, the total thermal energy (total thermal energy supply) is inclusive of the thermal energy supply from the RES 120.

Evaluation Process

In the evaluation process, two or more energy balance candidates for each time step UT are evaluated by an optimization algorithm (in this example, a genetic algorithm) in accordance with evaluation criteria including an electric energy supply cost based on a unit electric energy price, a thermal energy supply cost based on a unit thermal energy price, a CO₂ emission based on the electric energy output P1 of the CHP 110 and the electric energy output Pp of the large-scale electric power network 200, a CO₂ emission based on the thermal energy output Q1 of the CHP 110 and the thermal energy output Q5 of the backup thermal energy supply unit 150, a primary energy consumption based on the electric energy output P1 of the CHP 110 and the electric energy output Pp of the large-scale electric power network 200, and a primary energy consumption based on the thermal energy output Q1 of the CHP 110 and the thermal energy output Q5 of the backup thermal energy supply unit 150. In this context, primary energy is the energy directly obtainable from natural resources, like fossil fuels (e.g., coal, crude oil, and natural gas), hydraulic power, solar and geothermal power, and uranium, and expressed in kWh.

More particularly, the energy supply cost is obtained by adding a first electric energy supply cost, a second electric energy supply cost, a first thermal energy supply cost, and a second thermal energy supply cost together. The first electric energy supply cost is calculated by multiplying the electric energy output P1 of the CHP 110 obtained in the first calculation process and the unit electric energy price obtained in the input step together. The first thermal energy supply cost is calculated by multiplying the thermal energy output Q1 of the CHP 110 obtained in the first calculation process and the unit thermal energy price obtained in the input step together. The second electric energy supply cost is calculated by multiplying the electric energy output Pp of the large-scale electric power network 200 obtained in the second calculation process and the unit electric energy price obtained in the input step together. The second thermal energy supply cost is calculated by multiplying the thermal energy output Q5 of the backup thermal energy supply unit 150 obtained in the second calculation process and the unit thermal energy price obtained in the input step together.

The CO₂ emission is obtained by adding first, second and third CO₂ emissions together. The first CO₂ emission is obtained by converting the electric energy output P1 of the CHP 110 obtained in the first calculation process using a CO₂ emission conversion formula or table. The second CO₂ emission is obtained by converting the electric energy output Pp of the large-scale electric power network 200 obtained in the second calculation process using a CO₂ emission conversion formula or table. The third CO₂ emission is obtained by converting the thermal energy output Q5 of the backup thermal energy supply unit 150 obtained in the second calculation process using a CO₂ emission conversion formula or table. The CO₂ emission conversion formulas and tables are pre-recorded in the memory section 340. The conversion of the electric energy output P1 of the CHP 110 to a CO₂ emission, the conversion of the electric energy output Pp of the large-scale electric power network 200 to a CO₂ emission, the conversion of the thermal energy output Q1 of the CHP 110 to a CO₂ emission, and the conversion of the thermal energy output Q5 of the backup thermal energy supply unit 150 to a CO₂ emission can be carried out by a publicly known, conventional technique; no detailed description is given here.

The primary energy consumption is obtained by adding first, second and third primary energy consumptions together. The first primary energy consumption is obtained by converting the electric energy output P1 of the CHP 110 obtained in the first calculation process using a primary energy consumption conversion formula or table. The second primary energy consumption is obtained by converting the electric energy output Pp of the large-scale electric power network 200 obtained in the second calculation process using a primary energy consumption conversion formula or table. The third primary energy consumption is obtained by converting the thermal energy output Q5 of the backup thermal energy supply unit 150 obtained in the second calculation process using a primary energy consumption conversion formula or table. The primary energy consumption conversion formulas and tables are pre-recorded in the memory section 340. The conversion of the electric energy output P1 of the CHP 110 to a primary energy consumption, the conversion of the electric energy output Pp of the large-scale electric power network 200 to a primary energy consumption, the conversion of the thermal energy output Q1 of the CHP 110 to a primary energy consumption, and the conversion of the thermal energy output Q5 of the backup thermal energy supply unit 150 to a primary energy consumption can be carried out by a publicly known, conventional technique; no detailed description is given here.

In the evaluation process, two or more energy balance candidates for each time step UT are evaluated based on the energy supply costs, CO₂ emissions, and primary energy consumptions obtained in the above manner.

More particularly, in the evaluation process, an individual evaluation value is determined from an energy supply cost, a CO₂ emission, and a primary energy consumption by means of an objective function. A candidate will be evaluated progressively reliably with a greater or smaller individual evaluation value. In the present embodiment, a smaller individual evaluation value indicates that the candidate is more reliably evaluated. The objective function is pre-recorded in the memory section 340. The objective function includes as its variables an energy supply cost, a CO₂ emission, and a primary energy consumption. For example, in the evaluation process, the individual evaluation values of two or more energy balance candidates for each time step UT may be determined by plugging in their energy supply costs, CO₂ emissions, and primary energy consumptions into a predetermined evaluation formula. Alternatively, the individual evaluation values may be determined by ranking the energy supply costs, CO₂ emissions, and primary energy consumptions and summing up the ranks of the energy supply costs, the ranks of the CO₂ emissions, and the ranks of the primary energy consumptions. The evaluation process is however by no means limited to these examples.

When the evaluation process uses an electric power exchange profile as another evaluation criterion, progressively positive evaluation is given to a better matching between the total electric energy output of the large-scale electric power network 200 and the electric power demand in the electric power exchange profile. The power exchange profile requested by the large-scale electric power network can be satisfied by incorporating the electric power exchange profile into the evaluation process.

First Selection Process

In the first selection process, a most positively evaluated candidate is selected from the two or more energy balance candidates for each time step UT. The most positively evaluated candidate is one of these candidates that yields the most positive evaluation when the convergence of the individual evaluation values of the two or more candidates has reached predetermined convergence criteria. In the first selection process, the convergence of the individual evaluation values of the two or more candidates may be taken as having reached convergence criteria when the variance statistically calculated from the individual evaluation values of the two or more candidates comes to converge within convergence criteria. In the first selection process, a most positively evaluated candidate may be selected that yields the most positive evaluation when the evaluation is repeated a predetermined number of times (repetition count) even if the convergence of the individual evaluation values of the two or more candidates has not reached the convergence criteria. When this is the case, the most positively evaluated candidate that yields the most positive evaluation as a result of the combination of the energy supply cost, CO₂ emission, and primary energy consumption yielding the smallest or largest (in this example, the smallest) individual evaluation value (e.g., the evaluation value obtained from an evaluation formula or the evaluation value obtained from ranking) is selected from the two or more candidates in the first selection process.

Weighting Process

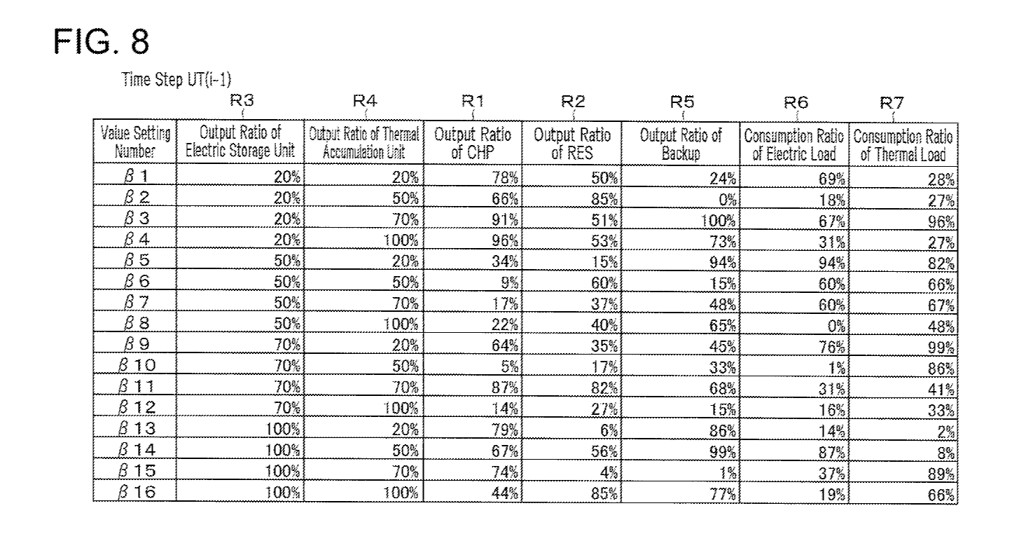

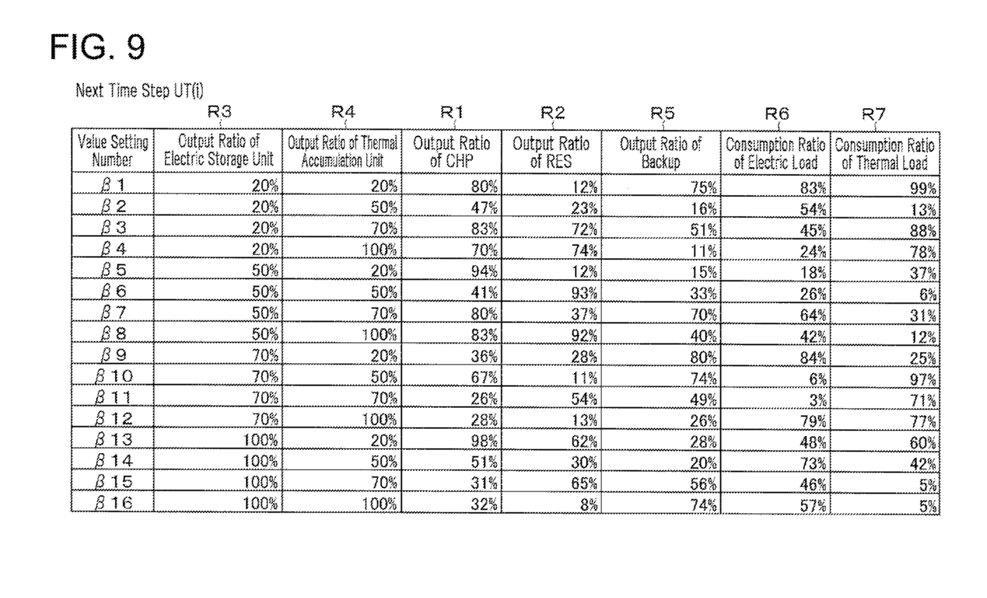

Related to the table in FIG. 6 of transitional evaluation values for evaluation by means of a combination of a plurality of value settings β1 to β16 in a transition from one time step UT(i−1) to next time step UT(i) over the entire operation period T, FIGS. 8 and 9 show tables of the output ratios R1, R2, and R5 of the CHP 110, the RES 120, and the backup thermal energy supply unit (BACKUP) 150 and the consumption ratios R6 and R7 of the electric load 160 and the thermal load 170 along with the output ratios R3 and R4 of the electric storage unit 130 and the thermal accumulation unit 140. FIG. 8 represents an example for time step UT(i−1), whereas FIG. 9 represents an example for next time step UT(i).

In the present embodiment, based on one of the transitional evaluation values obtained by means of a fitness function, the computing step gives a weight to each edge (in this example, at maximum, a total of 16×16×95=24320 edges: β1→β1, β1→β2, . . . , β16→β15, and β16→β16) from a plurality of levels (in this example, 16 combinations of four levels, 20%, 50%, 70%, and 100%, of the electric storage unit 130 and four levels, 20%, 50%, 70%, and 100%, of the thermal accumulation unit 140) of the energy storage units (in this example, the electric storage unit 130 and the thermal accumulation unit 140) for one of time steps UT(1) to UT(n) (specifically, time step UT(i−1)) to a plurality of levels (in this example, 16 combinations of four levels, 20%, 50%, 70%, and 100%, of the electric storage unit 130 and four levels, 20%, 50%, 70%, and 100%, of the thermal accumulation unit 140) of the energy storage units (in this example, the electric storage unit 130 and the thermal accumulation unit 140) for next time step UT(i) (see FIG. 6).

The transitional evaluation values are derived from evaluation conditions including at least one of the energy supply cost, the CO₂ emission, and the primary energy consumption.

More particularly, the transitional evaluation values are derived by means of a fitness function designed to reduce energy supply cost, CO₂ emission, and primary energy consumption in a transition (in this example, β1→β1, β1→β2, . . . , β16→β15, and β16→β16) from the value settings (in this example, β1 to β16) for one time step UT(i−1) to the value settings for next time step UT(i) by using, as parameters, the value settings for the CHP 110, the RES 120, the electric storage unit 130, the thermal accumulation unit 140, the electric load 160, the thermal load 170, and the backup thermal energy supply unit (BACKUP) 150. The fitness function, similarly to the evaluation process, can be determined in advance by including in evaluation criteria an electric energy supply cost based on a unit electric energy price, a thermal energy supply cost based on a unit thermal energy price, a CO₂ emission based on the electric energy output P1 of the CHP 110 and the electric energy output Pp of the large-scale electric power network 200, a CO₂ emission based on the thermal energy output Q1 of the CHP 110 and the thermal energy output Q5 of the backup thermal energy supply unit 150, a primary energy consumption based on the electric energy output P1 of the CHP 110 and the electric energy output Pp of the large-scale electric power network 200, and a primary energy consumption based on the thermal energy output Q1 of the CHP 110 and the thermal energy output Q5 of the backup thermal energy supply unit 150. The fitness function is pre-recorded in the memory section 340. For example, letting FF represent the fitness function, fitness function FF=γ1×|R1(i)−R1(i−1)|+γ2×|R2(i)−R2(i−1)|+γ3×|R3(i)−R3(i−1)|+γ4×|R4(i)−R4(i−1)|+γ5×|R5(i)−R5(i−1)|+γ6×|R6(i)−R6(i−1)|+γ7×|R7(i)−R7(i−1)|, where γ1 to γ7 are respective evaluation coefficients for the CHP 110, the RES 120, the electric storage unit 130, the thermal accumulation unit 140, the backup thermal energy supply unit 150, the electric load 160, and the thermal load 170 with the evaluation criteria above taken into consideration; R1(i) to R5(i), R6(i), and R7(i) are the output ratios R1 to R5 and the consumption ratios R6 and R7 respectively for time step UT(i); and R1(i−1) to R5(i−1), R6(i−1), and R7(i−1) are the output ratios R1 to R5 and the consumption ratios R6 and R7 respectively for time step UT(i−1).

Some of the combinations (in this example, 256 combinations: β1→β1, β1→β2, . . . , β16→β15, and β16→β16) of value settings (in this example, β1 to β16) in the transition from one time step UT(i−1) to next time step UT(i) do not allow for the transition from one time step UT(i−1) to next time step UT(i) due to, for example, technical constraints. As an example, the electric storage unit 130 only allows a limited temperature rise from one time step UT(i−1) to next time step UT(i) (in this example, 15 minutes) and may not be able to transition from the output ratio, 20%, for one time step UT(i−1) to the output ratio, 100%, for next time step UT(i). When this is actually the case, the transitional evaluation value is set to an impossible value (a value that is none of [1] to [7] in this example (e.g., [999])).

Shortest-Path Problem Solving Process

In addition, out of the combinations of value settings (in this example, the output ratios R1, R2, R3, R4, and R5 of the CHP 110, the RES 120, the electric storage unit 130, the thermal accumulation unit 140, and the backup thermal energy supply unit 150 and the consumption ratios R6 and R7 of the electric load 160 and the thermal load 170) resulting in the transitional evaluation values for time steps UT(1) to UT(n), the computing step determines, by a graph-theoretic shortest-path problem solving algorithm, a combination of value settings (in the example shown in FIG. 6, the value settings β2 for one time step UT(i−1), the value settings β13 for next time step UT(i), and the value settings β9 for further next time step UT(i+1)) for which the total sum of the transitional evaluation values for first time step UT(1) to last time step UT(n) is most positively evaluated (in the example shown in FIG. 6, . . . +[3]+[2]+ . . . ) (see FIG. 6).

The graph-theoretic shortest-path problem solving algorithm may be a publicly known, conventional technique. Typical examples include the Dijkstra algorithm, which addresses a single-starting-point shortest-path problem with no negative cycle (i.e., a cycle whose edges sum to a negative value), and the Bellman-Ford algorithm, which addresses a single-starting-point shortest-path problem with a negative cycle. The shortest-path problem solving algorithm in this example is a Dijkstra algorithm. The Dijkstra algorithm is a publicly known, conventional technique and therefore is not detailed here.

Second Selection Process

Then, in the computing step, the combination of value settings (in the example shown in FIG. 6, the value settings β2 for one time step UT(i−1), the value settings β13 for next time step UT(i), and the value settings β9 for further next time step UT(i+1)) determined by the shortest-path problem solving algorithm is selected for each time step UT(1) to UT(n) as the operational instruction values C1 (C11 and C12), C2 (C21 and C22), C5, C3, C6 (C62 to C64), and C7 (C72 to C74).

Output Step

In the output step, the value settings (in this example, output ratios R1 (R11 and R12), R2 (R21 and R22), R5, and R3 and the consumption ratios R6 (R62 to R64) and R7 (R72 to R74)) are transmitted for each time step UT(1) to UT(n) to the CHP 110, the RES 120, the electric storage unit 130, and the backup thermal energy supply unit 150, and when there additionally exist a controllable electric load 160 and a controllable thermal load 170, also to the controllable electric load 160 and thermal load 170, as the operational instruction values C1 (C11 and C12), C2 (C21 and C22), C5, C3, C6 (C62 to C64), and C7 (C72 to C74).

Then, in the output step, the operational instruction values C1 (C11 and C12), C2 (C21 and C22), C5, C3, C6 (C62 to C64), and C7 (C72 to C74) obtained in the second selection process for each time step UT are transmitted (outputted) respectively to the CHP 110, the RES 120, the backup thermal energy supply unit 150, the electric storage unit 130, the electric load 160, and the thermal load 170 as instructions to the CHP 110, the RES 120, the backup thermal energy supply unit 150, the electric storage unit 130, the electric load 160, and the thermal load 170.

More particularly, in the output step, the operational instruction values C1 (C11 and C12), C2 (C21 and C22), C5, C3, C6 (C62 to C64), and C7 (C72 to C74) corresponding to the output ratios R1 (R11 and R12) of the CHP 110, the output ratios R2 (R21 and R22) of the RES 120, the output ratio R5 of the backup thermal energy supply unit 150, the output ratio R3 of the electric storage unit 130, the consumption ratios R6 (R62 to R64) of the electric load 160, and the consumption ratios R7 (R72 to R74) of the thermal load 170, all obtained in the second selection process, are transmitted respectively to the CHP 110, the RES 120, the backup thermal energy supply unit 150, the electric storage unit 130, the electric load 160, and the thermal load 170.

Specifically, in the output step, as the operational instruction values obtained in the second selection process as a result of the evaluation over the entire operation period T (time steps UT(1) to UT(n)), the operational instruction values C11(1) to C11(N) corresponding respectively to the output ratios R11(1) to R11(N) of the electric energy P1 of the CHP 110 are transmitted to the CHP 110, the operational instruction values C12(1) to C12(N) corresponding respectively to the output ratios R12(1) to R12(N) of the thermal energy Q1 of the CHP 110 are transmitted to the CHP 110, the operational instruction values C21(1) to C21(N) corresponding respectively to the output ratios R21(1) to R21(N) of the photovoltaic power generator 121 (RES 120) are transmitted to the photovoltaic power generator 121, the operational instruction values C22(1) to C22(N) corresponding respectively to the output ratios R22(1) to R22(N) of the wind-powered electric generator 122 (RES 120) are transmitted to the wind-powered electric generator 122, the operational instruction values C5(1) to C5(N) corresponding respectively to the output ratios R5(1) to R5(N) of the backup thermal energy supply unit 150 are transmitted to the backup thermal energy supply unit 150, and the operational instruction values C3(1) to C3(N) corresponding respectively to the output ratios R3(1) to R3(N) of the electric storage unit 130 are transmitted to the electric storage unit 130.

N is an integer greater than or equal to 2 and, as mentioned earlier, indicates the number of processing units (e.g., 96 processing units) that is obtained by dividing the operation period to be processed (e.g., 1 day=24 hours) by the time step UT (e.g., 15 minutes=0.25 hours).

In the output step, as the operational instruction values obtained in the second selection process as a result of the evaluation over the entire operation period T (time steps UT(1) to UT(n)), the operational instruction values C62(1) to C62(N) corresponding respectively to the consumption ratios R62(1) to R62(N) of the second load L2, a part of the electric load 160, are transmitted to the second load L2 when the second load L2 consumes electric energy, the operational instruction values C63(1) to C63(N) corresponding respectively to the consumption ratios R63(1) to R63(N) of the third load L3, a part of the electric load 160, are transmitted to the third load L3 when the third load L3 consumes electric energy, and the operational instruction values C64(1) to C64(N) corresponding respectively to the consumption ratios R64(1) to R64(N) of the fourth load L4, a part of the electric load 160, are transmitted to the fourth load L4 when the fourth load L4 consumes electric energy.

Also in the output step, as the operational instruction values obtained in the second selection process as a result of the evaluation over the entire operation period T (time steps UT(1) to UT(n)), the operational instruction values C72(1) to C72(N) corresponding respectively to the consumption ratios R72(1) to R72(N) of the second load L2, a part of the thermal load 170, are transmitted to the second load L2 when the second load L2 consumes thermal energy, the operational instruction values C73(1) to C73(N) corresponding respectively to the consumption ratios R73(1) to R73(N) of the third load L3, a part of the thermal load 170, are transmitted to the third load L3 when the third load L3 consumes thermal energy, and the operational instruction values C74(1) to C74(N) corresponding respectively to the consumption ratios R74(1) to R74(N) of the fourth load L4, a part of the thermal load 170, are transmitted to the fourth load L4 when the fourth load L4 consumes thermal energy.

In the present embodiment, there is provided the single CHP 110. Alternatively, there may be provided a plurality of CHPs 110. In addition, although there are provided the two RES's 120, there may be provided a single RES 120 or three or more RES's 120.

As described above, according to the present embodiment, the output values (in this example, the output ratios R1, R2, R3, R4, and R5) of the CHP 110, the RES 120, the electric storage unit 130, the thermal accumulation unit 140, and the backup thermal energy supply unit 150, and when there additionally exist a controllable electric load 160 and a controllable thermal load 170, also the demands (in this example, the consumption ratios R6 and R7) of the controllable electric load 160 and thermal load 170 are computed as value settings by means of an optimization algorithm based on the input information for each time step UT(1) to UT(n) and for each level of the electric storage unit 130 and the thermal accumulation unit 140 (in this example, 16 combinations of four levels, 20%, 50%, 70%, and 100%, of the electric storage unit 130 and four levels, 20%, 50%, 70%, and 100%, of the thermal accumulation unit 140). Each edge (in this example, a total of 16×16=256 edges: β1→β1, β1→β2, . . . , β16→β15, and β16→β16) from a plurality of levels (in this example, 16 combinations of four levels, 20%, 50%, 70%, and 100%, of the electric storage unit 130 and four levels, 20%, 50%, 70%, and 100%, of the thermal accumulation unit 140) of the energy storage units (in this example, the electric storage unit 130 and the thermal accumulation unit 140) for one of time steps UT(1) to UT(n) (specifically, time step UT(i−1)) to a plurality of levels (in this example, 16 combinations of four levels, 20%, 50%, 70%, and 100%, of the electric storage unit 130 and four levels, 20%, 50%, 70%, and 100%, of the thermal accumulation unit 140) of the energy storage units (in this example, the electric storage unit 130 and the thermal accumulation unit 140) for next time step UT(i) is given a weight based on one of the transitional evaluation values obtained by means of a fitness function. Out of the combinations of value settings resulting in the transitional evaluation values for time steps UT(1) to UT(n), a combination of value settings (in the example shown in FIG. 6, the value settings 132 for one time step UT(i−1), the value settings β13 for next time step UT(i), and the value settings β9 for further next time step UT(i+1)) for which the total sum of the transitional evaluation values for first time step UT(1) to last time step UT(n) is most positively evaluated (in the example shown in FIG. 6, . . . +[3]+[2]+ . . . ) is determined by a graph-theoretic shortest-path problem solving algorithm. Then, the combination of value settings determined by the shortest-path problem solving algorithm is selected for the time steps UT(1) to UT(n) as the operational instruction values C1 (C11 and C12), C2 (C21 and C22), C5, C3, C6 (C62 to C64), and C7 (C72 to C74). The configuration of the present embodiment can hence practically achieve optimal operation of each piece of equipment, such as the energy generation units (in this example, the CHP 110 and the RES 120), the energy storage units (in this example, the electric storage unit 130 and the thermal accumulation unit 140), and the energy loads (in this example, the electric load 160 and the thermal load 170), throughout the entire operation period T.

In addition, the shortest-path problem solving algorithm in the present embodiment is a Dijkstra algorithm. Therefore, the present embodiment can reliably determine, out of the combinations of value settings resulting in the transitional evaluation values for time steps UT(1) to UT(n), a combination of value settings for which the total sum of the transitional evaluation values for first time step UT(1) to last time step UT(n) is most positively evaluated.

In addition, the optimization algorithm in the present embodiment is a genetic algorithm. Therefore, the present embodiment can quickly compute an output value for each level (in this example, four levels: 20%, 50%, 70%, and 100%) of energy generation units (in this example, the CHP 110 and the RES 120) and energy storage units (in this example, the electric storage unit 130 and the thermal accumulation unit 140) and for each time step UT(1) to UT(n), and when there additionally exist controllable energy loads (in this example, the electric load 160 and the thermal load 170), also quickly compute a demand for each level (e.g., four levels: 20%, 50%, 70%, and 100%) of the energy loads (in this example, the electric load 160 and the thermal load 170) and for each time step UT(1) to UT(n).

In addition, the scalar information in the present embodiment includes at least one of a set of value settings in an operation season mode and a set of value settings (in this example, the output ratios R1, R2, R3, R4, and R5 of the CHP 110, the RES 120, the electric storage unit 130, the thermal accumulation unit 140, and the backup thermal energy supply unit 150 and the consumption ratios R6 and R7 of the electric load 160 and the thermal load 170) for last time step UT(n) of an immediately preceding operation period (in this example, 1 day). Therefore, operation can be started by using the value settings for first time step UT(1) of a next operation period T (in this example, the operation period T for the next day) as initial values.

In addition, the vector information in the present embodiment includes at least one of an energy price, a time step-specific electric power price, an electric power demand, and a thermal power demand. Therefore, the present embodiment can obtain accurate transitional evaluation values by means of a fitness function.

In addition, the energy generation unit in the present embodiment includes the fuel gas-powered CHP 110 and/or the RES 120 (in this example, both the CHP 110 and the RES 120). Therefore, the present embodiment can efficiently supply thermal energy and electric energy.

In addition, the technical information in the present embodiment includes at least one of the rated output of the CHP 110, the conversion parameter for conversion of the electric energy output P1 of the CHP 110 to the fuel gas consumption of the CHP 110, and the conversion parameter for conversion of the electric energy output P1 of the CHP 110 to the thermal energy output Q1 of the CHP 110. Therefore, the present embodiment can obtain accurate individual evaluation values and transitional evaluation values by means of a fitness function.

In addition, the in-plant energy network 100 in the present embodiment further includes the backup thermal energy supply unit 150. Therefore, the backup thermal energy supply unit 150 can cover a thermal energy shortage in the in-plant energy network 100.

In addition, the transitional evaluation values in the present embodiment are derived from evaluation conditions including at least one of an energy supply cost, a CO₂ emission, and a primary energy consumption. Therefore, the present embodiment can carry out transitional evaluation based on at least one of an energy supply cost, a CO₂ emission, and a primary energy consumption.

In addition, in the present embodiment, in the input step (according to the input means PR1), forecast energy demands, unit energy prices, and forecast weather conditions are received. Then, in the first calculation process of the computing step (carried out by the computing means PR2), the outputs (electric energy P1 and thermal energy Q1) of the CHP 110 are calculated from the rated output of the CHP 110 and the output ratios R1 (R11 and R12) of the CHP 110; the outputs (in this example, electric energies P21 and P22) of the RES 120 are calculated from the maximum output of the RES 120 and the output ratios R2 (R21 and R22) of the RES 120, both based on weather conditions; the output (thermal energy Q5) of the backup thermal energy supply unit 150 is calculated from the rated output of the backup thermal energy supply unit 150 and the output ratio R5 of the backup thermal energy supply unit 150; the output (electric energy P3) of the electric storage unit 130 is calculated from the maximum output of the electric storage unit 130 and the output ratio R3 of the electric storage unit 130, both based on the state of charge; the electric energy consumption Q6 of the electric load 160 is calculated from the rated power consumption of the electric load 160 and the consumption ratio R6 of the electric load 160; and the thermal energy consumption Q7 of the thermal load 170 is calculated from the rated power consumption of the thermal load 170 and the consumption ratio R7 of the thermal load 170. In the second calculation process of the computing step, a difference between a total energy, or the sum of the outputs (electric energy P1 and thermal energy Q1) of the CHP 110, the outputs (in this example, electric energies P21 and P22) of the RES 120, the output (thermal energy Q4) of the thermal accumulation unit 140, and the output (electric energy P3) of the electric storage unit 130, and another total energy, or the sum of the uninterruptible electric and thermal energy consumption for energy demand, the electric energy consumption Q6 of the electric load 160, and the thermal energy consumption Q7 of the thermal load 170, is calculated as the output (electric energy Pp) of the large-scale electric power network 200 and the energy that can be supplied from the backup thermal energy supply unit 150. In the evaluation process, two or more candidates are evaluated using evaluation criteria including the energy supply cost (electric energy supply cost and thermal energy supply cost) based on a unit energy price, the outputs (electric energy P1 and thermal energy Q1) of the CHP 110, and the CO₂ emission and primary energy consumption based on the output (electric energy Pp) of the large-scale electric power network 200 and the output (thermal energy Q5) of the backup thermal energy supply unit 150. In the selection process, from the two or more energy balance candidates for each unit time, a most positively evaluated candidate is selected that yields the most positive evaluation when the convergence of the individual evaluation values of the two or more candidates has reached convergence criteria. In the output step (according to the output means PR3), the operational instruction values C1, C2, C5, C3, C6, and C7 for each unit time based on the most positively evaluated candidate are transmitted respectively to the CHP 110, the RES 120, the backup thermal energy supply unit 150, the electric storage unit 130, the electric load 160, and the thermal load 170. Therefore, the present embodiment is capable of reducing CO₂ emission and primary energy consumption, as well as energy supply cost, to lowest possible levels in optimal energy management.

Furthermore, in the present embodiment, an optimal scheduling for (the combination of) the output ratios R1, R2, R5, and R3 of the CHP 110, the RES 120, the backup thermal energy supply unit 150, and the electric storage unit 130 and the consumption ratios R6 and R7 of the electric load 160 and the thermal load 170 is found for the CHP 110, the RES 120, the backup thermal energy supply unit 150, the electric storage unit 130, the electric load 160, and the thermal load 170 in accordance with inputted energy demands, unit energy prices, and weather conditions by means of an objective function that takes into consideration energy supply costs, CO₂ emissions, and primary energy consumptions (in this example, to minimize the individual evaluation values obtained by means of the objective function) in residential areas, manufacturing industry areas, and tertiary areas. Hence, the present embodiment can specify optimal operation conditions for the CHP 110, the RES 120, the backup thermal energy supply unit 150, the electric storage unit 130, the electric load 160, and the thermal load 170.

In addition, in the present embodiment, the electric load 160 and the thermal load 170 can be classified into non-adjustable loads L1 that require uninterruptible energy consumption for energy demand, interruptible and adjustable loads L2, manageable loads L3 that, after starting to operate, may discontinue their operation if a total operation time is reached within a predetermined period, and manageable loads L4 that are not allowed to discontinue their operation until a total operation time is reached once it starts to operate. Hence, in the first calculation process, the calculations related to the energy consumption Q6 of the electric load 160 and the energy consumption Q7 of the thermal load 170 can be carried out in a manner more suitable to the actual circumstances. Accordingly, the output (electric energy Pp) of the large-scale electric power network 200 and the output (thermal energy Q4) supplied from the thermal accumulation unit 140 can be precisely calculated in the second calculation process.

As mentioned earlier, if a consumer fails to follow the electric power exchange profile, he/she is given a penalty from the utility company. The present embodiment is however capable of effectively preventing the consumer from being given a penalty from the utility company because the computing step (computing means PR2) includes as one of evaluation criteria how well the output (electric energy Pp) of the large-scale electric power network 200 matches the electric power exchange profile, so that evaluation can be done based on two or more electric power exchange profile candidates.

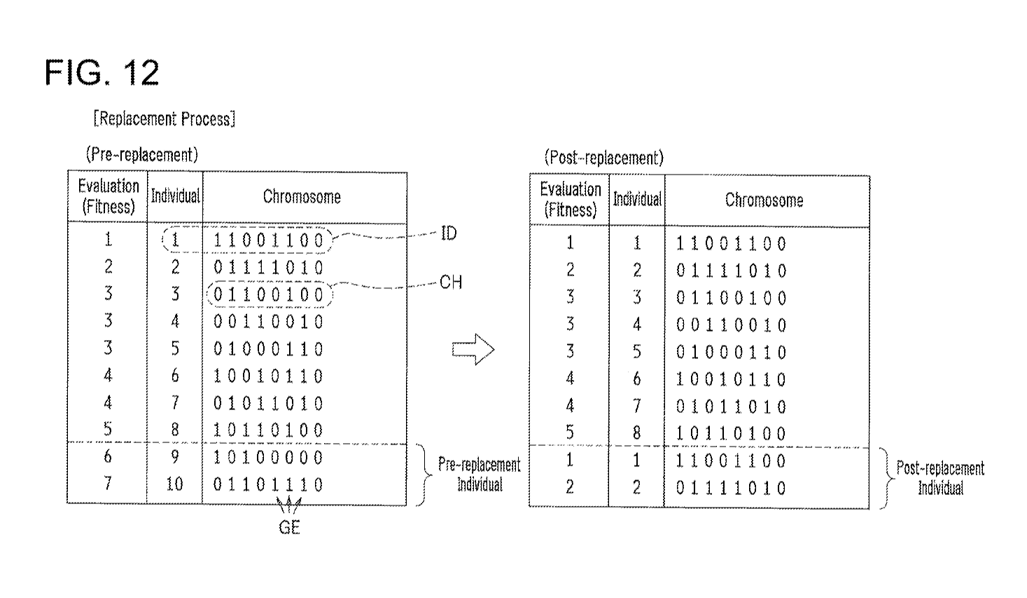

According to the present embodiment, in the computing step, the output ratio R1 of the CHP 110, the output ratio R2 of the RES 120, the output ratio R5 of the backup thermal energy supply unit 150, the consumption ratio R6 of the electric load 160, and the consumption ratio R7 of the thermal load 170 are coded as parts of a chromosome CH including a predetermined number (division count DI: for example, 2⁸=256) of genes GE; the output ratio R3 of the electric storage unit 130 and the output ratio R4 of the thermal accumulation unit 140 are coded as parts of the chromosome CH including a predetermined number (division count DJ: for example, 2²=4 and 2⁴=4) of genes GE; two or more candidates are coded as individuals ID; and two or more individuals ID are repeatedly generated for each one of the 16 combinations of the output ratio R3 of the electric storage unit 130 and the output ratio R4 of the thermal accumulation unit 140 based on a genetic algorithm (see FIG. 12 which will be described later in detail).

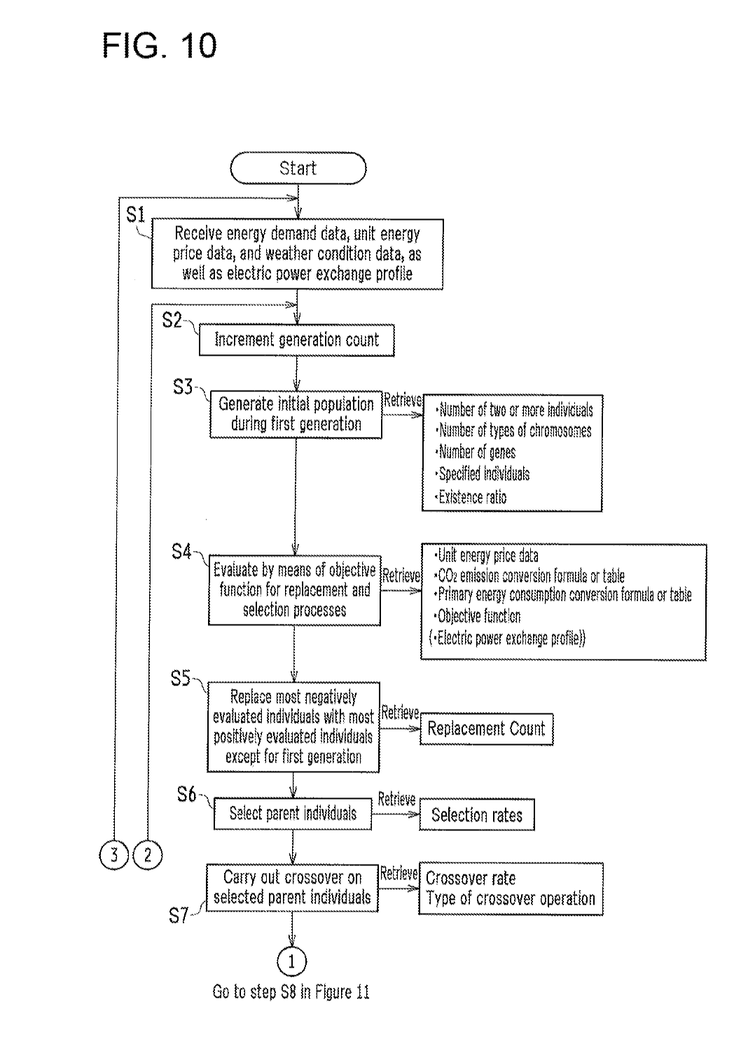

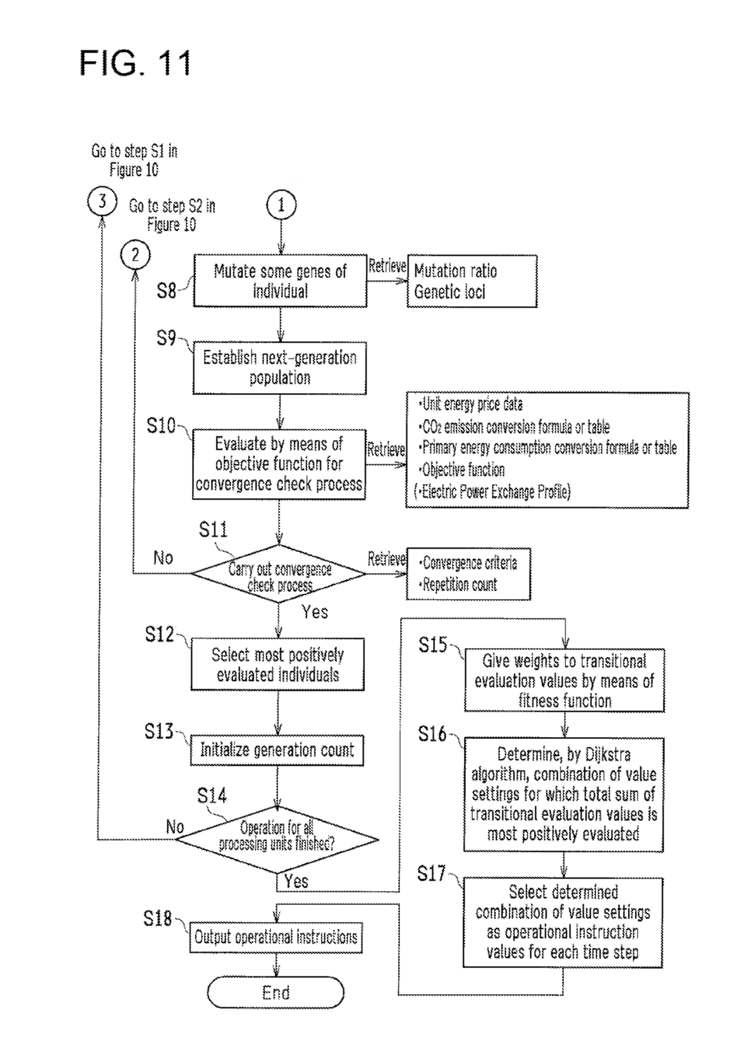

Referring to the flow charts shown in FIGS. 10 and 11, the following will describe the control device 300 of the in-plant energy network 100 in accordance with an embodiment of the present invention by taking a Dijkstra algorithm as an example of the shortest-path problem solving algorithm used in the shortest-path problem solving process and a genetic algorithm as an example of the optimization algorithm used in the evaluation process.

FIGS. 10 and 11 are flow charts representing an exemplary energy management evaluation optimization process performed by the control section 330 in the control device 300 shown in FIG. 7. FIG. 10 represents a first half of the exemplary process, and FIG. 11 represents a second half of the exemplary process.

The control section 330 optimizes energy management a number of times that is equal to the number of processing units (e.g., 96 processing units) that is obtained by dividing the operation period to be processed (e.g., 1 day=24 hours) by the time step UT (e.g., 15 minutes=0.25 hours) according to the genetic algorithm shown in FIGS. 10 and 11 (in this example, on the preceding day; specifically, collectively sometime on December 24 so that the optimization is completed by 00:00:00, December 25) before the forecast period for the energy demand data DT1 and the weather condition data DT3 (e.g., from 00:00:00 to 23:59:59, December 25).

In the optimization process represented in FIGS. 10 and 11, a set of two or more candidates is termed a population PP (group of individuals), and each candidate in the population PP is termed an individual ID.

Prior to implementing the optimization process represented in FIGS. 10 and 11, the following set of data is specified (stored) in advance in the memory section 340: the number of two or more individuals ID in the population PP (e.g., 1,000); the number of types of chromosomes CH (e.g., 13, or the sum of the “2” types of output ratios R11 and R12 of the CHP 110, the “2” types of output ratios R21 and R22 of the RES 120, the “1” type of output ratio R5 of the backup thermal energy supply unit 150, the “1” type of output ratio R3 of the electric storage unit 130, the “1” type of output ratio R4 of the thermal accumulation unit 140, the “3” types of consumption ratios R62 to R64 of the electric load 160, and the “3” types of consumption ratios R72 to R74 of the thermal load 170); and the number of genes GE (e.g., 256=8 bits in binary form, or the division count DI for the output ratios R11 and R12 of the CHP 110, the output ratios R21 and R22 of the RES 120, the output ratio R5 of the backup thermal energy supply unit 150, the consumption ratios R62 to R64 of the electric load 160, and the consumption ratios R72 to R74 of the thermal load 170, and 4=2 bits in binary form, or the division count DJ for the output ratio R3 of the electric storage unit 130 and the output ratio R4 of the thermal accumulation unit 140). Specified individuals ID and an existence ratio, a replacement count, selection rates, a crossover rate and the type of crossover operation, a mutation ratio and genetic loci, and convergence criteria and a repetition count, all of which will be described later in detail, are also specified (stored) in advance in the memory section 340. The control device 300 allows the user to readily specify these values and conditions. This configuration enables the control device 300 to be readily applicable in environments in residential areas, manufacturing industry areas, and tertiary areas in which the in-plant energy network 100 is installed.

Step S1: Data Input

First of all, as illustrated in FIG. 10, the control section 330 receives the energy demand data DT1 for each time step UT (e.g., 15 minutes) in relation to forecast energy demands, the unit energy price data DT2 for each time step UT (e.g., 15 minutes) in relation to unit energy prices, and the weather condition data DT3 for each time step UT (e.g., 15 minutes) in relation to forecast weather conditions of the geographical region covered by the in-plant energy network 100 (step S1). In this example, the control section 330 also receives the electric power exchange profile of the large-scale electric power network 200 in step S1 as part of the energy demand data DT1 for each time step UT (e.g., 15 minutes).

Specifically, the control section 330 obtains, as the energy demand data DT1, the forecast electric power demands, forecast thermal energy demands, and electric power exchange profile directly inputted by the user through the input section 310. The control section 330 automatically obtains, as the unit energy price data DT2, a unit electric energy price and a unit thermal energy price from a Web site on the Internet 400. The control section 330 automatically obtains, as the weather condition data DT3, the angle of the sun and cloudiness in the geographical region where the photovoltaic power generator 121 is installed and the wind direction and speed in the geographical region where the wind-powered electric generator 122 is installed from a Web site on the Internet 400.

Step S2: Incrementing Generation Count

Next, the control section 330 increments (increases by one) a generation count G (initially set to 0; G=G+1) (step S2).

Step S3: Generating Initial Population

Next, the control section 330, during the first generation (G=1), generates an initial (first generation) population PP from all combinations of the output ratios R11 and R12 of the CHP 110, the output ratios R1 and R22 of the RES 120, the output ratio R5 of the backup thermal energy supply unit 150, the output ratio R3 of the electric storage unit 130, the output ratio R4 of the thermal accumulation unit 140, the consumption ratios R62 to R64 of the electric load 160, and the consumption ratios R72 to R74 of the thermal load 170 (step S3). In step 3, the output ratio R4 of the thermal accumulation unit 140 is logically dictated by the balance of the thermal energies Q1, Q7, and Q5 of the CHP 110, the thermal load 170, and the backup thermal energy supply unit 150. Therefore, the output ratio R12 of the CHP 110, the consumption ratios R72 to R74 of the thermal load 170, and the output ratio R5 of the backup thermal energy supply unit 150 can assume a limited number of values in accordance with the 16 combinations of the four levels, 20%, 50%, 70%, and 100%, of the output ratio R3 of the electric storage unit 130 and the four levels, 20%, 50%, 70%, and 100%, of the output ratio R4 of the thermal accumulation unit 140. The control section 330 stores the generated population PP in the memory section 340.

Specifically, the control section 330 selects two or more (e.g., 1,000) individuals ID, as the initial population PP, from all the individuals (e.g., 2⁹²=256¹¹×4² individuals), that is, all the combinations of as many output ratios R11 and R12 of the electric energy P1 and the thermal energy Q1 of the CHP 110 as the division count DI (e.g., 2⁸=256) by which the entire output range of the CHP 110 is divided, as many output ratios R21 and R22 of the RES 120 (in this example, the photovoltaic power generator 121 and the wind-powered electric generator 122) as the division count DI by which the entire output range of the RES 120 is divided, as many output ratios R5 of the backup thermal energy supply unit 150 as the division count DI by which the entire output range of the backup thermal energy supply unit 150 is divided, as many output ratios R3 of the electric storage unit 130 as the division count DJ (e.g., 2²=4) by which the entire output range of the electric storage unit 130 is divided, as many output ratios R4 of the thermal accumulation unit 140 as the division count DJ (e.g., 2²=4) by which the entire output range of the thermal accumulation unit 140 is divided, as many consumption ratios R62 to R64 of the electric load 160 (the second load L2 to the fourth load L4) as the division count DI by which the entire consumption range of the electric load 160 is divided, and as many consumption ratios R72 to R74 of the thermal load 170 (the second load L2 to the fourth load L4) as the division count DI by which the entire consumption range of the thermal load 170 is divided, so that the initial population PP can be statistically distributed (specifically, the initial population PP can have randomness) for each one of the 16 combinations of a plurality of levels (in this example, four levels: 20%, 50%, 70%, and 100%) of the electric storage unit 130 and a plurality of levels (in this example, four levels: 20%, 50%, 70%, and 100%) of the thermal accumulation unit 140.

Furthermore, the control section 330 deliberately specifies predetermined individuals that are to exist in advance at a predetermined existence ratio in the initial population PP. For example, when there are 1,000 individuals ID with an existence ratio of 5%, 50 out of the 1,000 individuals ID are the specified individuals existent in advance.

In the present embodiment, for example, the specified individuals consist of the following three types of individuals.

1. Individuals that lead to electric power-led operation of the CHP 110 (the CHP 110 is operated following the electric power demand of the electric load 160)

2. Individuals that lead to thermal power-led operation of the CHP 110 (the CHP 110 is operated following the thermal power demand of the thermal load 170)

3. Individuals that lead to such operation of the CHP 110 and the RES 120 that all the electric power demand of the electric load 160 is fulfilled by the supply of the electric energy Pp from the large-scale electric power network 200 and all the thermal power demand of the thermal load 170 is fulfilled by the supply of the thermal energy Q5 from the backup thermal energy supply unit 150.

To do this, the control section 330 refers to the memory section 340 to retrieve the number (e.g., 1,000) of the two or more (e.g., 1,000) individuals ID, the number of types of chromosomes CH (in this example, 10 (types)), the number of genes GE (e.g., 8 bits in binary form), the specified individuals existent in advance (in this example, three types of individuals), and the existence ratio of the specified individuals to the individuals ID in the population PP, all being stored in the memory section 340.

Step S4: Evaluation for Replacement Process and Selection Process

Next, the control section 330 evaluates two or more (e.g., 1,000) individuals ID in the current generation population PP by means of an objective function to carry out a replacement process in step S5 and a selection process in step S6 (step S4).

Specifically, the control section 330 determines individual evaluation values for the two or more (e.g., 1,000) individuals ID either by plugging in their energy supply costs, CO₂ emissions, and primary energy consumptions into a predetermined evaluation formula in the evaluation process or by ranking the energy supply costs, CO₂ emissions, and primary energy consumptions and summing up the rank of the energy supply cost, the rank of the CO₂ emission, and the rank of the primary energy consumption for each individual ID in the evaluation process. In addition, in this example, the control section 330 incorporates the electric power exchange profile as one of evaluation criteria; therefore, the control section 330 gives a progressively positive evaluation to a better matching between the total electric energy output Pp of the large-scale electric power network 200 and the electric power demand in the electric power exchange profile (e.g., if a smaller evaluation value represents a progressively positive evaluation, the evaluation value is multiplied by an evaluation ratio that decreases with a better matching).

To do this, the control section 330 refers to the memory section 340 to retrieve the unit energy price data DT2, the CO₂ emission conversion formula or table, the primary energy consumption conversion formula or table, the objective function, and the electric power exchange profile, all stored in the memory section 340.

Step S5: Replacing Most Negatively Evaluated Individuals with Most Positively Evaluated Individuals

Next, except for the first generation (G=1), the control section 330 carries out a replacement process of replacing most negatively evaluated individuals with most positively evaluated individuals of the two or more (e.g., 1,000) individuals ID in the population PP based on the evaluation (fitness) obtained in step S4 (step S5). The control section 330 then stores the post-replacement population PP in the memory section 340.

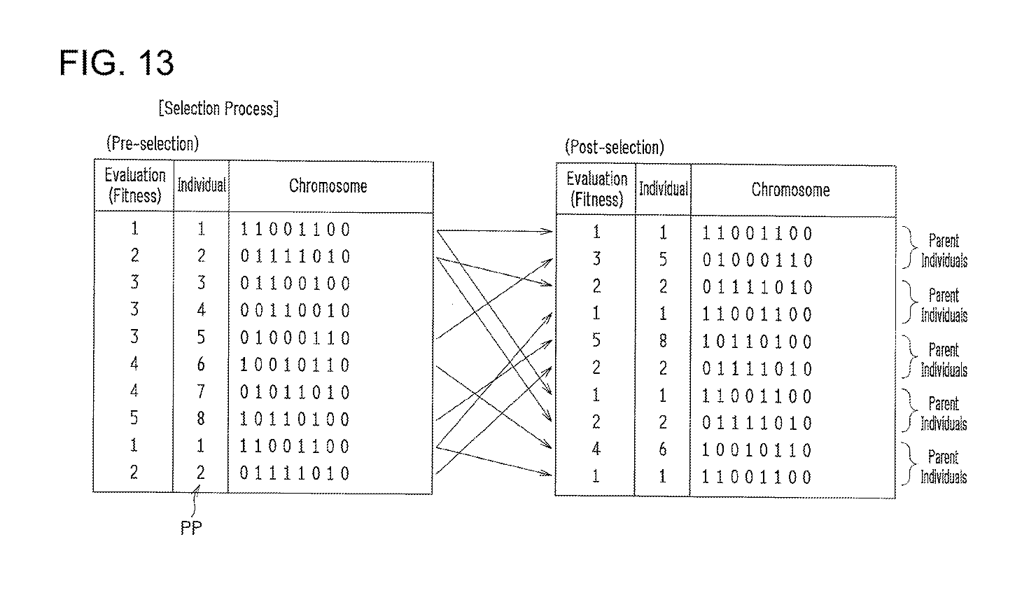

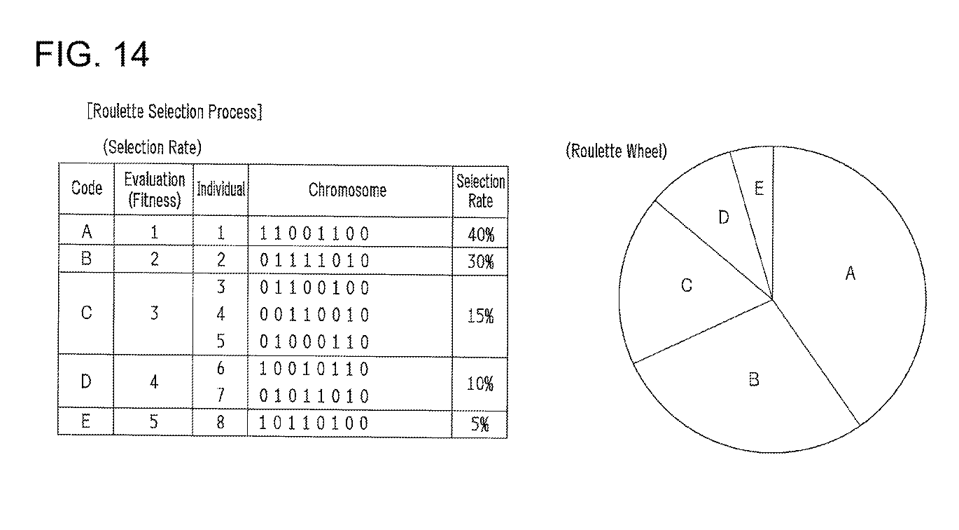

FIG. 12 is a schematic diagram illustrating an exemplary replacement process by which some of the individuals ID in the population PP are replaced, the left half representing the population before the replacement, the right half representing the population after the replacement. Note that in the example shown in FIG. 12, for ease of description, the two or more individuals ID include ten individuals in the population PP, and the evaluation values (fitness) of the ten individuals 1 to 10 are given as 1, 2, 3, 3, 3, 4, 4, 5, 6, and 7. The evaluation is progressively positive with a smaller value. This applies to FIGS. 13 and 14, which will be described later in detail.

Specifically, as illustrated in FIG. 12, the control section 330 replaces as many individuals that were most negatively evaluated (fitness) in step S4 as the predetermined replacement count (two in the example shown in FIG. 12: individual [9] evaluated “6” and individual [10] evaluated “7” in the example shown in FIG. 12) out of the two or more (ten in the example shown in FIG. 12) individuals ID with as many individuals that were most positively evaluated as the replacement count (two in the example shown in FIG. 12: individual [1] evaluated “1” and individual [2] evaluated “2” in the example shown in FIG. 12).

To do this, the control section 330 refers to the memory section 340 to retrieve the predetermined replacement count (in this example, two) stored in the memory section 340.

Step S6: Selecting Parent Individuals

Next, the control section 330 carries out a selection process of selecting parent individuals from the two or more (e.g., 1,000) individuals ID in the population PP based on the evaluation (fitness) obtained in step S4 (step S6). The control section 330 stores the selected population PP in the memory section 340.

FIG. 13 is a schematic diagram illustrating an exemplary selection process by which parent individuals are selected from the two or more individuals ID in the population PP, the left half representing the population before the selection, the right half representing the population after the selection.

Specifically, as illustrated in FIG. 13, the control section 330 selects parent individuals (5 sets of parents in the example shown in FIG. 13) from the two or more (ten in the example shown in FIG. 13) individuals ID so that relatively positively evaluated individuals are more likely to be selected as parent individuals whereas relatively negatively evaluated individuals are less likely to be selected as parent individuals. This selection process may be any publicly known, conventional selection process and may typically be a roulette selection process, a ranking selection process, a tournament selection process, or an elite selection process. The roulette selection process utilizes a roulette wheel prepared according to the predetermined selection rates that are proportional to evaluation values, to enable a random selection.

FIG. 14 is a diagram illustrating an exemplary roulette selection process, the left half representing selection rates, the right half representing a roulette wheel prepared according to the selection rates.

As an example, suppose that ten individuals 1, 2, 3, 4, 5, 6, 7, 8, 1, and 2 before the selection process are evaluated 1, 2, 3, 3, 3, 4, 4, 5, 1, and 2 respectively as shown in the left half of FIG. 13 and given selection rates 40% (evaluation “1”), 30% (evaluation “2”), 15% (evaluation “3”), 10% (evaluation “4”), and 5% (evaluation “5”) as shown in the left half of FIG. 14. A roulette wheel is prepared using these selection rates as shown in the right half of FIG. 14. Since there are ten individuals, the roulette wheel is, for example, rotated 10 times to select ten post-selection individuals 1, 5, 2, 1, 8, 2, 1, 2, 6, and 1 shown in the right half of FIG. 13.

To do this, the control section 330 refers to the memory section 340 to retrieve the selection rates stored in the memory section 340.

Step S7: Crossover of Selected Parent Individuals

Next, the control section 330 carries out a crossover operation of exchanging some of the genes GE between arbitrarily (specifically, randomly) selected parent individuals (two individuals or chromosomes CH) at a predetermined crossover rate, or a probability at which the parent individuals selected in step S6 undergo crossover, to generate children (two next-generation individuals) (step S7). This process generates children that possess some of the parent individuals' genes GE. A next-generation population PP is obtained in this manner. The control section 330 then stores the generated next-generation population PP in the memory section 340. In addition, the control section 330 leaves, in the memory section 340, the current generation population PP that was selected in the selection process in step S7, as well as the next-generation population PP.

Specifically, the control section 330 exchanges some genes GE between the parent individuals (two individuals) at one or multiple crossover points to generate children (two next-generation individuals). This crossover operation may be a publicly known, conventional crossover operation and may be typically one-point crossover, multiple-point crossover, or uniform crossover. One-point crossover is an operation of randomly designating a single site as a crossover point in the chromosomes CH and exchanging the genes GE preceding or succeeding those sites between the parent individuals. Multiple-point crossover is an operation randomly designating a plurality of sites as crossover points in the chromosomes CH and exchanging the genes GE preceding or succeeding those sites between the parent individuals. Multiple-point crossover is typically two-point crossover. The control section 330, in the present embodiment, allows the user to specify any one of crossover operations: one-point crossover and two-point crossover.

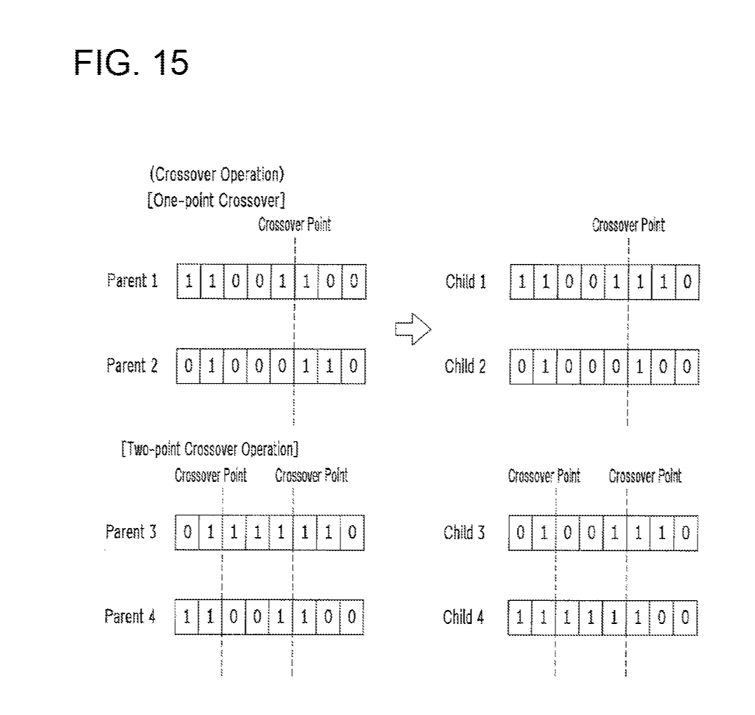

FIG. 15 is a schematic diagram illustrating an exemplary one-point crossover operation and an exemplary two-point crossover operation, the upper half representing a one-point crossover operation, the lower half representing a two-point crossover operation. In the examples shown in FIG. 15, there are provided eight (8 bits in binary form) genes GE in each individual ID for ease of description.

In the one-point crossover operation example shown in the upper half of FIG. 15, with the crossover point being located between the fifth and sixth bits from the left, the genes GE either from the first to fifth bits or from the sixth to eighth bits are exchanged between the parent individuals (two individuals).

In the two-point crossover operation example shown in the lower half of FIG. 15, with one of the crossover points being located between the second and third bits from the left and the other crossover point being located between the fifth and sixth bits from the left, the genes GE either from the third to fifth bits or from the first to second bits and from the sixth to eighth bits are exchanged between the parent individuals (two individuals).

To do this, the control section 330 refers to the memory section 340 to retrieve the crossover rate and the type of crossover operation (in this example, either one-point crossover or two-point crossover), both stored in the memory section 340.

Step S8: Gene Mutation in Individuals

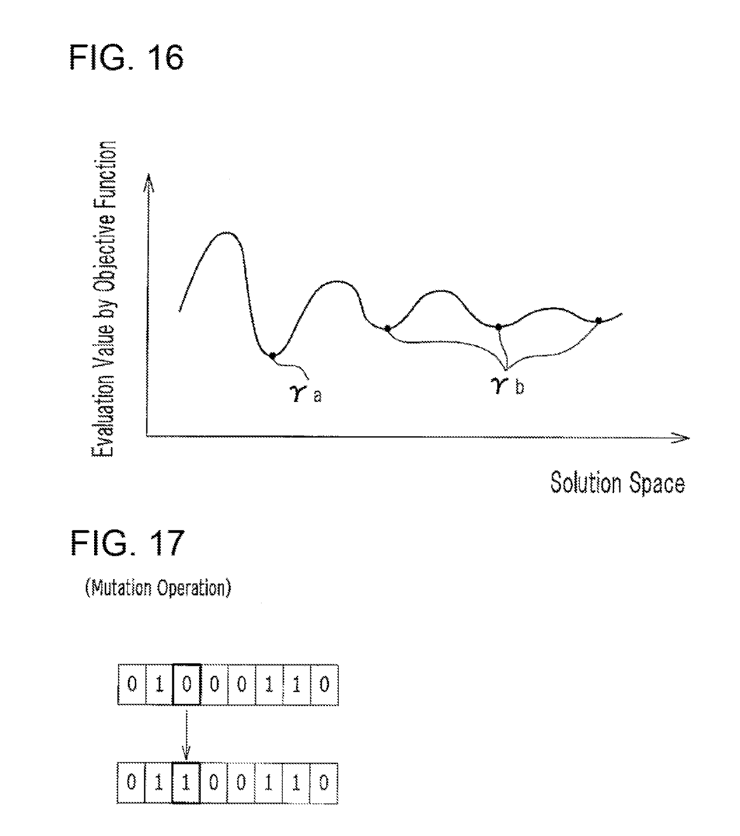

FIG. 16 is an illustration of local solutions γb that are likely to be found along with an optimal solution γa during the generation of a next-generation population PP.

If the control section 330 was capable only of crossover operations, limited child variants would be generated depending on the genes GE of the parent individuals. If so, the control section 330 could fail to give diversity to the population PP, and the algorithm would likely come up with a local solution (see γb in FIG. 16) that is not the desirable optimal solution (see γa in FIG. 16).

Regarding this point, however, the control section 330 carries out a mutation operation of replacing some of the genes GE in an arbitrarily (specifically, randomly) selected individual ID (chromosome CH) with their allelic genes at a predetermined mutation ratio, or a probability at which mutations occur in a next-generation population PP that underwent the selection operation in step S6 and the crossover operation in step S7 as illustrated in FIG. 11 (step S8). This operation gives diversity to the population PP, hence preventing the algorithm from coming up with a local solution that is not the desirable optimal solution.

Specifically, the control section 330 changes the value of a selected gene GE in a parent individual (chromosome CH) to a different value (e.g., reverses the selected bit in binary form). The mutation operation may be a publicly known, conventional mutation operation and may be typically a single-locus mutation operation, an inversion operation, or a translocation operation. Single-locus mutation is an operation of replacing a gene with its allelic gene at a single genetic locus. In the present embodiment, the control section 330 allows the user to specify genetic loci in a mutation operation.

FIG. 17 is a schematic diagram illustrating an exemplary single-locus mutation operation. In the example shown in FIG. 17, there are provided eight (8 bits in binary form) genes GE in an individual ID for ease of description.

In the single-locus mutation operation example shown in FIG. 17, the 0 in the third bit (genetic locus) is reversed to a 1.

To do this, the control section 330 refers to the memory section 340 to retrieve the mutation ratio and the genetic locus (in this example, the third bit), both stored in the memory section 340.

Step S9: Establishing Next-Generation Population

Next, the control section 330 establishes a next-generation population PP that underwent the crossover operation in step S7 and the mutation operation in step S8 (step S9). The control section 330 then stores the established next-generation population PP in the memory section 340.

Step S10: Evaluation for Convergence Check

Next, the control section 330 evaluates two or more (e.g., 1,000) individuals ID in the current generation population PP obtained in step S7 by means of an objective function to carry out a convergence check process in step S11 (step S10).

Specifically, the control section 330 determines individual evaluation values for the two or more (e.g., 1,000) individuals ID either by plugging in their energy supply costs, CO₂ emissions, and primary energy consumptions into a predetermined evaluation formula in the evaluation process or by ranking the energy supply costs, CO₂ emissions, and primary energy consumptions and summing up the rank of the energy supply cost, the rank of the CO₂ emission, and the rank of the primary energy consumption for each individual ID in the evaluation process. In addition, in this example, the control section 330 incorporates the electric power exchange profile as one of evaluation criteria; therefore, the control section 330 gives a progressively positive evaluation to a better matching between the total electric energy output Pp of the large-scale electric power network 200 and the electric power demand in the electric power exchange profile (e.g., if a smaller evaluation value represents a progressively positive evaluation, the evaluation value is multiplied by an evaluation ratio that decreases with a better matching).

To do this, the control section 330 refers to the memory section 340 to retrieve the unit energy price data DT2, the CO₂ emission conversion formula or table, the primary energy consumption conversion formula or table, the objective function, and the electric power exchange profile, all stored in the memory section 340.

Step S11: Convergence Check Process

Next, the control section 330 carries out a convergence check process of determining whether or not the changes of the individual evaluation values (fitness) of the two or more (e.g., 1,000) candidates in the current generation population PP evaluated in step S10 have reached convergence criteria and whether or not the generation count G has reached a predetermined repetition count (step S11). If the convergence of the individual evaluation values has not reached the convergence criteria and the generation count G has not reached the predetermined repetition count (“No” in step S11), the control section 330 proceeds to and carries out step S2 shown in FIG. 10 with the next-generation population PP established in step S9 being designated as the current generation population PP and repeats steps S2 to S11. At least either if the convergence of the individual evaluation values has reached the convergence criteria or if the generation count G has reached the predetermined repetition count (“Yes” in step S11), the control section 330 proceeds to and carries out step S12.

To do this, the control section 330 retrieves the predetermined convergence criteria and the predetermined repetition count.

Step S12: Selecting Most Positively Evaluated Individual

Next, the control section 330 selects a most positively evaluated individual that is to be a most positively evaluated (best fitness) individual (step S12).

Step S13: Initializing Generation Count

Next, the control section 330 initializes the generation count G (sets the generation count G to 0) (step S13).

Step S14: Operations for Each Processing Unit

Next, the control section 330 carries out steps S1 to S14 of the genetic algorithm for each processing unit (e.g., 96 processing units), or time step UT (e.g., 15 minutes) (“No” in step S14).

As explained above, in the present embodiment, the computing step (computing means) is capable of converging the convergence of the individual evaluation values of the two or more individuals within the convergence criteria in a short period of time, by coding the output ratio R1 of the CHP 110, the output ratio R2 of the RES 120, the output ratio R5 of the backup thermal energy supply unit 150, the output ratio R3 of the electric storage unit 130, the output ratio R4 of the thermal accumulation unit 140, the consumption ratio R6 of the electric load 160, and the consumption ratio R7 of the thermal load 170 into a chromosome CH, coding two or more (e.g., 1,000) candidates into individuals ID, and repeatedly generating two or more (e.g., 1,000) individuals ID according to a genetic algorithm for each one of the 16 combinations of the output ratio R3 of the electric storage unit 130 and the output ratio R4 of the thermal accumulation unit 140.

Step S15: Weighting Process Based on Transitional Evaluation Values by Means of Fitness Function

Following the completion of the process for each processing unit (“Yes” in step S14), the control section 330 gives weights to a total of 163316=256 edges, β1→β1, β1→β2, . . . , β16→β15, and β16→β16, from the 16 combinations of the four levels, 20%, 50%, 70%, and 100%, of the electric storage unit 130 and the four levels, 20%, 50%, 70%, and 100%, of the thermal accumulation unit 140 for one of time steps UT(1) to UT(n) (specifically, time step UT(i−1)) to the 16 combinations of the four levels, 20%, 50%, 70%, and 100%, of the electric storage unit 130 and the four levels, 20%, 50%, 70%, and 100%, of the thermal accumulation unit 140 for next time step UT(i) based on the transitional evaluation values obtained by means of a fitness function (step S15).

Step S16: Dijkstra Algorithm Process

Next, out of the combinations of value settings (in this example, the output ratios R1, R2, R3, R4, and R5 of the CHP 110, the RES 120, the electric storage unit 130, the thermal accumulation unit 140, and the backup thermal energy supply unit 150 and the consumption ratios R6 and R7 of the electric load 160 and the thermal load 170) resulting in the transitional evaluation values for time steps UT(1) to UT(n), the control section 330 determines, by means of a Dijkstra algorithm, a combination of value settings (in the example shown in FIG. 6, the value settings β2 for one time step UT(i−1), the value settings β13 for next time step UT(i), and the value settings β9 for further next time step UT(i+1)) for which the total sum of the transitional evaluation values for first time step UT(1) to last time step UT(n) is most positively evaluated (in the example shown in FIG. 6, . . . +[3]+[2]+ . . . ) (step S16).

Step S17: Selecting Value Settings

Next, the control section 330 selects the combination of value settings (in the example shown in FIG. 6, the value settings β2 for one time step UT(i−1), the value settings β13 for next time step UT(i), and the value settings β9 for further next time step UT(i+1)) determined by means of the Dijkstra algorithm as the operational instruction values C1 (C11 and C12), C2 (C21 and C22), C5, C3, C6 (C62 to C64), and C7 (C72 to C74) for the time steps UT(1) to UT(n) (step S17).

Steps S1 to S17 may be implemented before the processing for the day of interest is started (e.g., sometime between approximately 20:00, December 24 (preceding day) and when the processing is started on the day of interest).

Step S18: Output of Operational Instruction Values

Next, the control section 330 transmits (outputs), respectively to the CHP 110, the RES 120 (121, 122), the backup thermal energy supply unit 150, the electric storage unit 130, the electric load 160 (from the second load L2 to the fourth load L4), and the thermal load 170 (from the second load L2 to the fourth load L4), the operational instruction values C1 (C11 and C12), C2 (C21 and C22), C5, C3, C6 (C62 to C64), and C7 (C72 to C74) corresponding to the combination, yielding the most positively evaluated individual for the time steps UT, of the output ratios R1 (R11 and R12) of the CHP 110, the output ratios R2 (R21 and R22) of the RES 120, the output ratio R5 of the backup thermal energy supply unit 150, the output ratio R3 of the electric storage unit 130, the consumption ratios R6 (R62 to R64) of the electric load 160, and the consumption ratios R7 (R72 to R74) of the thermal load 170, in accordance with the processing units (e.g., 96 processing units) of the corresponding time steps UT (e.g., 15 minutes) before the forecast period (e.g., from 23:45:00 to 23:59:59, the preceding day (December 24) to 23:44:59, the day of interest (December 25)) (step S18). Then, the control section 330 ends the energy management evaluation optimization process.

Steps S1 to S17 may be further implemented on the day of interest after updating the input data acquired in step S1. Specifically, the control section 330 may update the latest energy management evaluation optimization process on the day of interest based on the latest information for each time step UT (e.g., 15 minutes) from current time step UT(i) to last time step TU (n). This configuration enables use of the latest energy demand data DT1, unit energy price data DT2, and weather condition data DT3, which in turn allows for a more accurate energy management evaluation optimization process.

There are provided seven individual evaluation values and seven transitional evaluation values in the embodiment described above. Alternatively, more or less than 7 values may be provided. In addition, the number of individual evaluation values may differ from the number of transitional evaluation values. In addition, a smaller evaluation value indicates more positive evaluation in the embodiment described above. Alternatively, a greater evaluation value may indicate more positive evaluation.

The division count DI, in the embodiment described above, for the output ratio R1 of the CHP 110, the output ratio R2 of the RES 120, the output ratio R5 of the backup thermal energy supply unit 150, the consumption ratio R6 of the electric load 160, and the consumption ratio R7 of the thermal load 170 is 256. Alternatively, the division count DI may be greater or smaller than 256. In addition, the division count DJ for the output ratios R3 and R4 of the electric storage unit 130 and the thermal accumulation unit 140 is 4 in the embodiment described above. Alternatively, the division count DJ may be greater or smaller than 4.

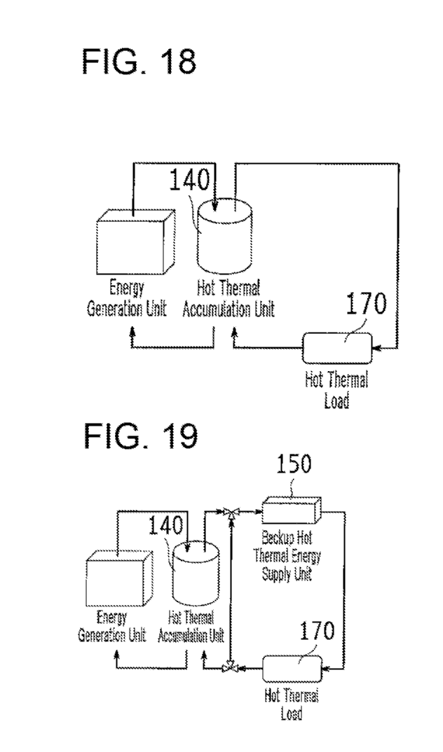

The in-plant energy network 100, in the embodiment described above, includes the CHP 110, the RES 120, the electric storage unit 130, the thermal accumulation unit 140, the backup thermal energy supply unit 150, the electric load 160, and the thermal load 170. Alternatively, the in-plant energy network 100 may be configured as shown in FIGS. 18 to 29. FIG. 18 is a schematic diagram of another exemplary in-plant energy network 100 in accordance with another embodiment of the present invention. FIGS. 19 to 29 are schematic diagrams of other exemplary in-plant energy networks 100 in accordance with other embodiments of the present invention.

In the example shown in FIG. 18, the in-plant energy network 100 includes an energy generation unit, a thermal accumulation unit (hot thermal accumulation unit) 140, and a thermal load (hot thermal load) 170. The in-plant energy network 100, in this example, is configured to manage hot thermal energy for desirable overall performance without including a backup thermal energy supply unit (backup hot thermal energy supply unit) 150.

In the example shown in FIG. 19, the in-plant energy network 100 includes an energy generation unit, a thermal accumulation unit (hot thermal accumulation unit) 140, a backup thermal energy supply unit (backup hot thermal energy supply unit) 150, and a thermal load (hot thermal load) 170. The in-plant energy network 100, in this example, is configured to manage hot thermal energy for desirable overall performance, with the backup thermal energy supply unit (backup hot thermal energy supply unit) 150 included in the in-plant energy network 100.

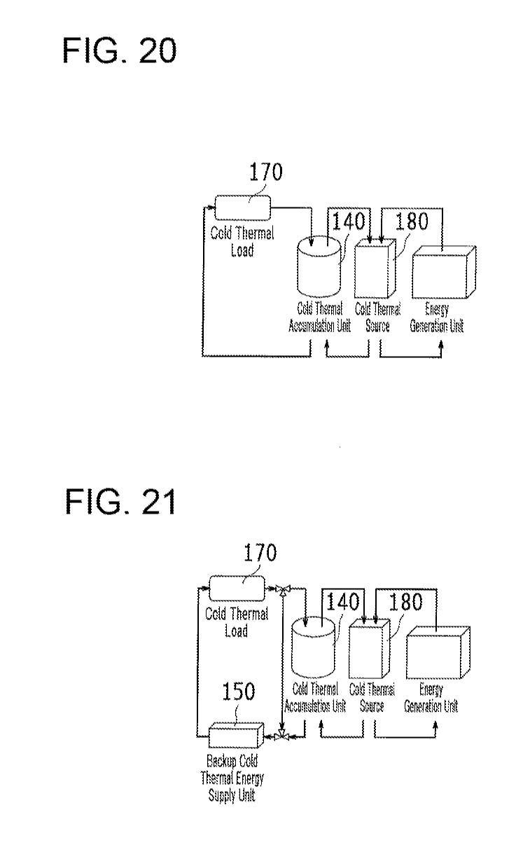

In the example shown in FIG. 20, the in-plant energy network 100 includes a thermal load (cold thermal load) 170, a thermal accumulation unit (cold thermal accumulation unit) 140, a cold thermal source 180, and an energy generation unit. The in-plant energy network 100, in this example, is configured to manage cold thermal energy for desirable overall performance without including a backup thermal energy supply unit (backup cold thermal energy supply unit) 150.

In the example shown in FIG. 21, the in-plant energy network 100 includes a thermal load (cold thermal load) 170, a backup thermal energy supply unit (backup cold thermal energy supply unit) 150, a thermal accumulation unit (cold thermal accumulation unit) 140, a cold thermal source 180, and an energy generation unit. The in-plant energy network 100, in this example, is configured to manage cold thermal energy for desirable overall performance, with the backup thermal energy supply unit (backup cold thermal energy supply unit) 150 included in the in-plant energy network 100.

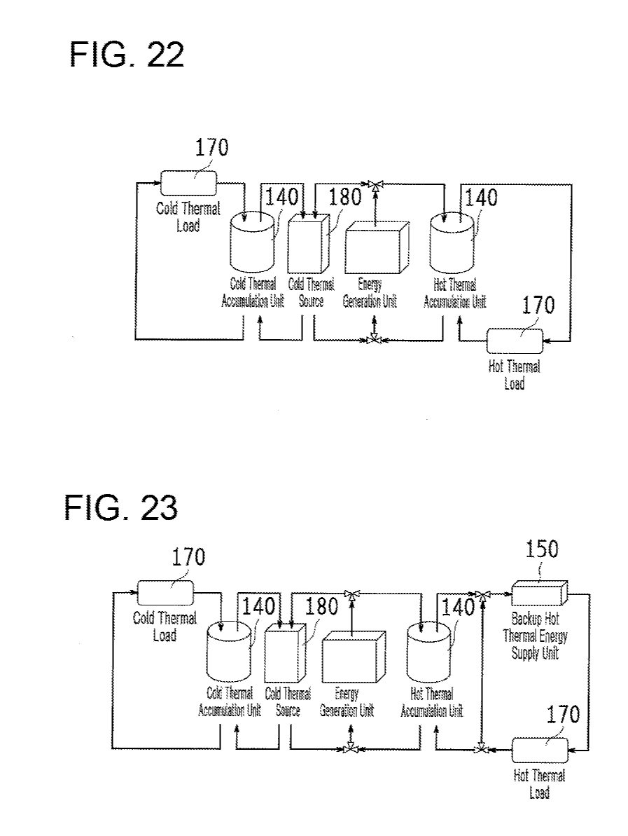

In the example shown in FIG. 22, the in-plant energy network 100 includes a thermal load (cold thermal load) 170, a thermal accumulation unit (cold thermal accumulation unit) 140, a cold thermal source 180, an energy generation unit, a thermal accumulation unit (hot thermal accumulation unit) 140, and a thermal load (hot thermal load) 170. The in-plant energy network 100, in this example, is configured to manage cold thermal energy and hot thermal energy for desirable overall performance without including a backup thermal energy supply unit (backup cold thermal energy supply unit) 150 or a backup thermal energy supply unit (backup hot thermal energy supply unit) 150.

In the example shown in FIG. 23, the in-plant energy network 100 includes a thermal load (cold thermal load) 170, a thermal accumulation unit (cold thermal accumulation unit) 140, a cold thermal source 180, an energy generation unit, a thermal accumulation unit (hot thermal accumulation unit) 140, a backup thermal energy supply unit (backup hot thermal energy supply unit) 150, and a thermal load (hot thermal load) 170. The in-plant energy network 100, in this example, is configured to manage cold thermal energy and hot thermal energy for desirable overall performance without including a backup thermal energy supply unit (backup cold thermal energy supply unit) 150, but with the backup thermal energy supply unit (backup hot thermal energy supply unit) 150 included in the in-plant energy network 100.

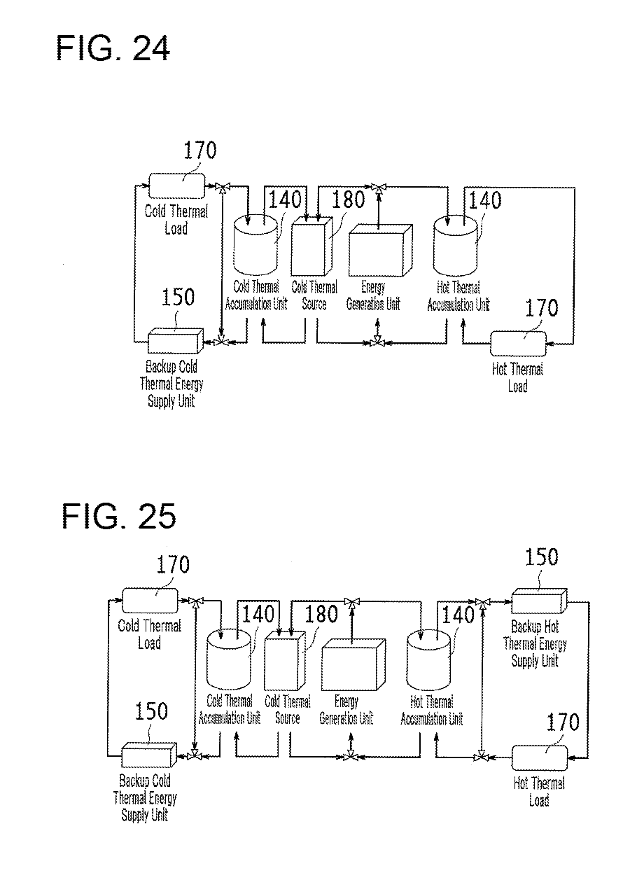

In the example shown in FIG. 24, the in-plant energy network 100 includes a thermal load (cold thermal load) 170, a backup thermal energy supply unit (backup cold thermal energy supply unit) 150, a thermal accumulation unit (cold thermal accumulation unit) 140, a cold thermal source 180, an energy generation unit, a thermal accumulation unit (hot thermal accumulation unit) 140, and a thermal load (hot thermal load) 170. The in-plant energy network 100, in this example, is configured to manage cold thermal energy and hot thermal energy for desirable overall performance without including a backup thermal energy supply unit (backup hot thermal energy supply unit) 150, but with the backup thermal energy supply unit (backup cold thermal energy supply unit) 150 included in the in-plant energy network 100.

In the example shown in FIG. 25, the in-plant energy network 100 includes a thermal load (cold thermal load) 170, a backup thermal energy supply unit (backup cold thermal energy supply unit) 150, a thermal accumulation unit (cold thermal accumulation unit) 140, a cold thermal source 180, an energy generation unit, a thermal accumulation unit (hot thermal accumulation unit) 140, a backup thermal energy supply unit (backup hot thermal energy supply unit) 150, and a thermal load (hot thermal load) 170. The in-plant energy network 100, in this example, is configured to manage cold thermal energy and hot thermal energy for desirable overall performance, with both the backup thermal energy supply unit (backup cold thermal energy supply unit) 150 and the backup thermal energy supply unit (backup hot thermal energy supply unit) 150 included in the in-plant energy network 100.

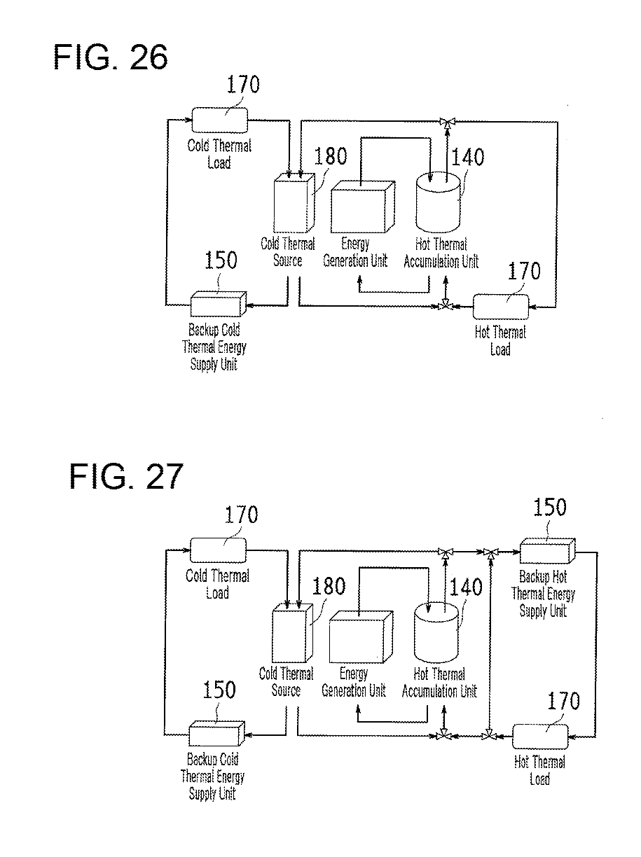

The in-plant energy network 100 in the example shown in FIG. 26 is configured similarly to the example shown in FIG. 24, but includes no thermal accumulation unit (cold thermal accumulation unit) 140 and has the energy generation unit directly connected to the thermal accumulation unit (hot thermal accumulation unit) 140.

The in-plant energy network 100 in the example shown in FIG. 27 is configured similarly to the example shown in FIG. 25, but includes no thermal accumulation unit (cold thermal accumulation unit) 140 and has the energy generation unit directly connected to the thermal accumulation unit (hot thermal accumulation unit) 140.

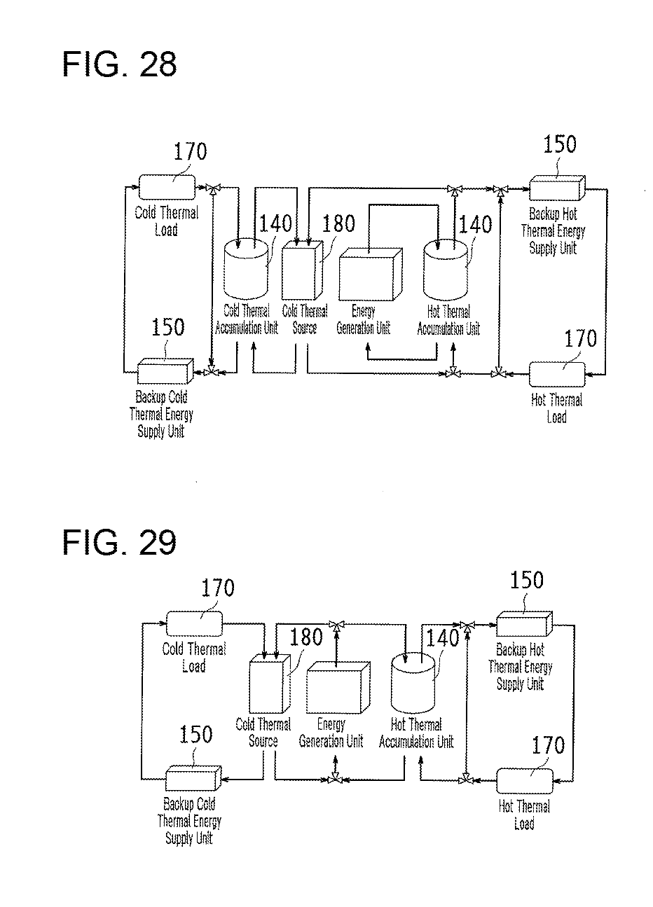

The in-plant energy network 100 in the example shown in FIG. 28 is configured similarly to the example shown in FIG. 25, but has the energy generation unit directly connected to the thermal accumulation unit (hot thermal accumulation unit) 140.

The in-plant energy network 100 in the example shown in FIG. 29 is configured similarly to the example shown in FIG. 25, but includes no thermal accumulation unit (cold thermal accumulation unit) 140.

Alternative Embodiment

In the embodiments, for example, the operations of the electric storage unit 130 and the thermal accumulation unit 140 may be carried out as described below.

The operations of the electric storage unit 130 and the thermal accumulation unit 140 are divided into different levels (energy levels). If considering, for example, 5 levels, then the charge differences between all the levels in time step UT(i) and all the levels in time step UT(i−1) are written into a matrix; these differences determine an energy balance: this energy balance is summed (with its sign, negative or positive) so that new fictional loads are calculated. After that, these fictional loads are optimized by the genetic algorithm, giving back a matrix with the fitness values for each possible configuration and connection between time step UT(i) and time step UT(i−1). After all the possible configurations for all the time steps UT (UT(1) to UT(n)) in the operation period T are optimized by the genetic algorithm, Dijkstra algorithm evaluates the optimized path during the operation period T, by calculating the minimum path (in terms of at least one of energy supply cost, CO₂ emission, and primary energy consumption) and selecting just one of the possible configurations for each time step UT. The electric storage unit 130 and the thermal accumulation unit 140 are never considered in the genetic algorithm, so the operating levels of the electric storage unit 130 and the thermal accumulation unit 140 are never assigned a value between 0 and 255.

By combining the columns for the output ratios R3 and R4 of the electric storage unit 130 and the thermal accumulation unit 140 in FIGS. 8 and 9, and by the knowledge of the maximum energy content of the electric storage unit 130 and the thermal accumulation unit 140, the power for passing from one state to another can be evaluated.

For example, assume the 20% value of the electric storage unit 130 for time step UT(i−1) and 50% for time step UT(i) and also assume the 70% value of the thermal accumulation unit 140 for time step UT(i−1) and 50% for time step UT(i). Considering that the electric storage unit 130 has a maximum capacity of 15 kWh and that the thermal accumulation unit 140 has a maximum capacity of 20 kWh, the resulting energy difference is +4.5 kWh (=15 kWh×0.5-15 kWh×0.2) for the electric storage unit 130 and −4 kWh (=20 kWh×0.5-20 kWh×0.7) for the thermal accumulation unit 140; if the duration of the time step UT is 15 minutes, the corresponding required power is +18 kW and −16 kW, respectively. These power values are respectively summed to the electric load 160 and the thermal load 170, and the results are the fictional loads that are optimized by the genetic algorithm, that never explicitly considers the energy storage units.

After all the possible passages are plotted in a matrix and optimized by the genetic algorithm, fitness results are plotted in another matrix, and the Dijkstra algorithm evaluates the best passage from one UT to another, corresponding to the best possible use of both the energy storage units and the energy generation units.

The above-described combination of levels is a mere example. Any other combinations are possible. The present embodiment is therefore not limited to that combination.

The present invention is by no means limited to the foregoing embodiments and may be implemented in many other forms. Therefore, the embodiments are merely illustrative in every point and should not be interpreted in a limiting manner. The scope of the present invention is defined in the claims and is by no means bound by the specification at all. Furthermore, the scope of the present invention encompasses all the changes and modifications that are equivalents of the claims.

### INDUSTRIAL APPLICABILITY

The present invention relates to control devices for optimizing evaluation of energy management in an in-plant energy network and is especially applicable for the purpose of practically achieving optimal operation of each piece of equipment, such as energy generation units, energy storage units, and energy loads, throughout an entire predetermined operation period.

### REFERENCE SIGNS LIST

100 In-plant Energy Network
110 Combined Heat and Power Device (CHP)
111 Open/close Valve
112 Gas Engine
113 Electric Power Generator
114 Electric Power Converter
115 AC Circuit Breaker
116 Waste Heat Recovery Boiler
117 Adjusting Valve
120 Renewable Energy Source (RES)
121 Photovoltaic Power Generator
121a Solar Cell Panel
121b Solar-generated Electric Power Inverter
121c AC Circuit Breaker
122 Wind-powered Electric Generator
122a Wind Turbine
122b Wind-generated Electric Power Inverter
122c AC Circuit Breaker
130 Electric Storage Unit
131 Rechargeable Battery
132 Electric Storage Inverter
133 AC Circuit Breaker
140 Thermal Accumulation Unit
141 Thermal Accumulator
142 Thermal Energy Regulation Unit
150 Backup Thermal Energy Supply Unit
151 Fuel Flow Rate Regulation Valve
152 Boiler
153 Adjusting Valve
160 Electric Load
170 Thermal Load
180 Cold Thermal Source
200 Large-scale Electric Power Network
201 Central Power Plant
210 Residential Area
211 General Household
220 Manufacturing Industry Area
221 Factory
230 Tertiary Area
231 Office
240 Small-scale Wind-powered Plant
250 Electric Vehicle
270 Electric Storage Unit
280 Fuel Cell
290 Large-scale Wind-powered Plant
300 Control Device
310 Input Section
320 Display Unit
330 Control Section
340 Memory Section
341 Volatile Memory
342 Non-volatile Memory
350 First Reading Section
360 Second Reading Section
400 Internet
C1 Operational Instruction Value
C11 Operational Instruction Value
C12 Operational Instruction Value
C2 Operational Instruction Value
C21 Operational Instruction Value
C22 Operational Instruction Value
C3 Operational Instruction Value
C5 Operational Instruction Value
C6 Operational Instruction Value
C62 Operational Instruction Value
C63 Operational Instruction Value
C64 Operational Instruction Value
C72 Operational Instruction Value
C73 Operational Instruction Value
C74 Operational Instruction Value
CH Chromosome
DT1 Energy Demand Data
DT2 Unit Energy Price Data
DT3 Weather Condition Data
F Fuel Supply Source
GE Gene
ID Individual
L1 First Load
L2 Second Load
L3 Third Load
L4 Fourth Load
M Storage Medium
ME External Storage Medium
P1 Electric Energy
P2 Electric Energy
P3 Electric Energy
PL Electric Power Supply Line
PP Population
PR Computer Program
PR1 Input Means
PR2 Computing Means
PR3 Output Means
Q1 Thermal Energy
Q4 Thermal Energy
Q5 Thermal Energy
T Operation Period
TL Heat Supply Line
UT Time Step

1. A control device optimizing evaluation of energy management in an in-plant energy network, said control device comprising an input section, a computing section, and an output section,
the in-plant energy network being connected to a large-scale electric power network and including an energy generation unit, an energy storage unit, and an energy load,
the input section being configured to allow input of input information for calculation of value settings for optimizing the evaluation of energy management in the in-plant energy network,
the input information including vector information that is changeable over an entire predetermined operation period, scalar information that does not change throughout the entire operation period, and technical information representing characteristics of the energy generation unit and the energy storage unit,
the computing section being configured to:
compute, based on the input information, an output value of the energy generation unit and an output value of the energy storage unit and when the energy load includes a controllable energy load, also a demand of the controllable energy load, as the value settings by means of a predetermined optimization algorithm for each one of time steps into which the operation period is divided and for each one of predetermined levels of the energy storage unit;
give a weight to each edge from the levels of the energy storage unit for one of the time steps to the levels of the energy storage unit for a next one of the time steps based on one of transitional evaluation values obtained by means of a fitness function;
determine, out of combinations of the value settings resulting in the transitional evaluation values for the time steps, a combination of the value settings for which a total sum of the transitional evaluation values for a first one of the time steps to a last one of the time steps is most positively evaluated, by means of a graph-theoretic shortest-path problem solving algorithm; and
select the combination of the value settings determined by means of the shortest-path problem solving algorithm as operational instruction values for each one of the time steps,
the output section being configured to transmit the selected combination of the value settings as the operational instruction values to the energy generation unit and the energy storage unit and when the energy load includes the controllable energy load, also to the controllable energy load, for each one of the time steps.

2. The control device according to claim 1, wherein the shortest-path problem solving algorithm is a Dijkstra algorithm.

3. The control device according to claim 1, wherein the optimization algorithm is a genetic algorithm.

4. The control device according to claim 1, wherein the vector information includes: at least one of an energy price, a time step-specific electric power price, an electric power demand, and a thermal power demand.

5. The control device according to claim 1, wherein the scalar information includes at least one of a set of value settings in an operation season mode and a set of value settings for a last time step of an immediately preceding operation period.

6. The control device according to claim 1, wherein the energy generation unit includes a combined heat and power device (CHP) running on fuel gas and/or a renewable energy source (RES).

7. The control device according to claim 6, wherein the technical information includes at least one of a rated output of the CHP, a conversion parameter for conversion of an electric energy output of the CHP to a fuel gas consumption of the CHP, and a conversion parameter for conversion of the electric energy output of the CHP to a thermal energy output of the CHP.

8. The control device according to claim 1, wherein:
the in-plant energy network further includes a backup thermal energy supply unit,
the technical information further includes technical information representing characteristics of the backup thermal energy supply unit,
the computing section computes the output value of the energy generation unit, the output value of the energy storage unit, and an output value of the backup thermal energy supply unit and when the energy load includes the controllable energy load, also computes the demand of the controllable energy load, as the value settings by means of the optimization algorithm for each one of the time steps and for each one of the levels of the energy storage unit, and
the output section transmits the selected combination of the value settings as the operational instruction values to the energy generation unit, the energy storage unit, and the backup thermal energy supply unit and when the energy load includes the controllable energy load, also to the controllable energy load, for each one of the time steps.

9. The control device according to claim 1, wherein the transitional evaluation values are derived from an evaluation condition including at least one of an energy supply cost, a CO₂ emission, and a primary energy consumption.
